(19) United States
(12) Patent Application Publication
(10) Pub. No.: US 2016/0321610 A1
(43) Pub. Date: Nov. 3, 2016

(54) SYSTEMS AND METHODS FOR AGGREGATING CONSUMER DATA

(71) Applicant: Adam Stein, Eagle, ID (US)

(72) Inventor: Adam Stein, Eagle, ID (US)

(21) Appl. No.: 14/965,383

(22) Filed: Dec. 10, 2015

Related U.S. Application Data
(60) Provisional application No. 62/155,371, filed on Apr. 30, 2015.

(51) Int. Cl. G06Q 10/10; G06F 21/62

(52) U.S. Cl. CPC G06Q 10/10; G06F 21/6254

(57) ABSTRACT

Systems and methods for providing anonymized transparent exchange of information are disclosed. Systems and method configured to facilitate consumer purchases and vendor marketing of financial services are disclosed. The systems and methods can allow consumers to anonymously browse offers of financial services and provides anonymous consumer data to one or more vendors of financial services. The systems and methods allow vendors to offer financial services or transactions to a consumer based on that consumer's validated financial data, without giving the vendor identifying data about the consumer. Further, the disclosed embodiments enable aggregation of consumer data according to one or more relevant tracking metrics or consumer characteristics. The disclosed embodiments can facilitate overall marketing of financial services to decrease the time and the effort required to close an accepted offer of financial services.

### RELATED APPLICATIONS

This application claims priority to U.S. Provisional Patent Application No. 62/155,371, titled SYSTEMS AND METHODS FOR ANONYMIZED TRANSPARENT TRANSACTIONS, filed Apr. 30, 2015, all subject matter of which is hereby incorporated herein by reference to the extent such subject matter is not inconsistent herewith.

### TECHNICAL FIELD

The present disclosure relates to systems and methods for exchanging information, and more particularly to systems and methods for providing anonymized transparent exchange of information such as between vendors and consumers to facilitate transactions.

### BACKGROUND

Information exchange can be hampered by inaccurate or incorrect initial representations (whether intentional or inadvertent) that may later require adjustment of responsive information. Also, information exchange can be hampered by concerns of potential parties to the exchange as to how the information might be used, particularly when the information to be exchanged may involve sensitive information. A party requested, or even required, to share information that is that is highly personal, identifying, confidential, proprietary, and/or the like may be reluctant to share such information with another party who has not yet earned trust and confidence. The sharing party may proceed with great trepidation as to how the receiver might use the information.

As one example, presently a consumer seeking a financial service, such as a loan, may inadvertently inflate a credit score, an annual income, or the like, simply tending toward optimism. Or the consumer may be reluctant to share identifying and/or sensitive financial information with a vendor out of concern that the vendor may use the information in the future to advertise additional products or otherwise solicit additional business from the consumer. As such, consumers may be reluctant to seek estimates or quotes for services from unfamiliar vendors.

Vendors may similarly experience apprehension to provide proprietary data, such as terms of an offer to provide services (e.g., financial services) to unfamiliar consumers.

Consequently, exchanging of information can often involve multiple partial exchanges as the parties gain familiarity and trust with each other and gather increasing levels of information. A consumer provides initial representations, that may later be discovered as inaccurate, inflated, embellished, or simply changed. The repeated back and forth to request and transfer information can draw out and significantly prolong exchanges of information. Similarly, parties can spend weeks to gather supporting or validating documentation to validate information received, which similarly prolongs exchanges of information.

Continuing with the example of a consumer seeking a financial service, such as a loan, the consumer may initially provide hypothetical or approximate financial information (e.g., bald, unsupported assertions as to credit score, employment status, income, etc.) to a vendor. Often consumers believe their information is accurate, but it is not. Initial representations as to credit score, income, and liabilities owed may be inadvertently inaccurate, inflated, or embellished. Or information of an initial representation that at one time would have been correct, may have simply changed. In another scenario, the consumer may favor providing hypothetical information in order to remain anonymous and avoid potential adverse consequences of sharing information, including but not limited to being subjected to undesired advertising campaigns, initiating an undesired permanent record with a vendor, and identity theft. Given that the information from the consumer may be inaccurate or even hypothetical, the vendor in turn may provide hypothetical or potential financial offer terms (e.g., max loan amount, interest rate, loan period, etc.) to the consumer, based solely on the hypothetical or approximate financial data of the consumer.

Even were the consumer to provide supporting documentation to corroborate financial information of the consumer, the vendor may hesitate to proceed with acceptance of assertions and/or documentation without undergoing a validation process, such as underwriting, to check a likelihood or probability that the consumer data provided by a consumer is accurate.

These challenges to exchange accurate information in a safe (e.g., anonymous) manner can result in generation of vendor offers that are also not accurate, which can lead to a series of counter offers and exchanges of revised information.

The vendor understandably may be more reticent to respond to a merely hypothetical consumer, for example, to avoid disclosing proprietary or other information that may put the vendor at a competitive disadvantage, or simply because providing a more precise response is burdensome or not possible absent additional information not then provided by the consumer. Even if the consumer has no concerns for anonymity, uncertainty remains as to the accuracy of the consumer's representations. Thus, after this initial transfer of information, if the parties share a mutual interest in further engagement, subsequent transfers of information occur to validate previously exchanged information and/or provide validated data to the exchange.

In certain situations, such as preparatory to a financial transaction, the parties' exchanges of information can prolong closing of a transaction for days and even weeks. For example, underwriters sometimes spend weeks to validate and/or verify the information representations of a consumer seeking a financial service.

Accordingly, systems and methods to facilitate anonymized and transparent exchange of information may be useful and desirable.

### SUMMARY

The present disclosure provides systems and methods for anonymous and transparent exchange of information such as between consumer(s) and vendor(s). The disclosed embodiments can enable a consumer to anonymously provide validated information, such as to a vendor. The disclosed embodiments can enable a vendor to receive accurate and validated information, on which actual offers may be more efficiently generated for real (albeit anonymous) consumers. The disclosed embodiments can provide to vendors information of visitors to the vendor's website or place of business while maintaining anonymity of the visitors and ensuring accuracy of the information. The disclosed embodiments may allow any parties to anonymously and transparently exchange any type of information with a heightened level of certainty that received information is accurate.

### BRIEF DESCRIPTION OF THE DRAWINGS

Additional aspects and advantages will be apparent from the following detailed description of preferred embodiments, which proceeds with reference to the accompanying drawings, in which:

FIG. 1 is a block diagram illustrating a system for facilitating anonymized and transparent exchange of information, according to one embodiment of the present disclosure.

FIG. 2 is block diagram of a consumer portal of a system for facilitating anonymized and transparent exchange of information, according to one embodiment of the present disclosure.

FIG. 3 is block diagram of a vendor portal of a system for facilitating anonymized and transparent exchange of information, according to one embodiment of the present disclosure.

FIG. 4 is a relationship diagram of a system for facilitating anonymized and transparent exchange of information, according to another embodiment of the present disclosure, illustrating receipt of consumer data and transfer of validated anonymized consumer data.

FIG. 5 is a relationship diagram of the system for facilitating anonymized and transparent exchange of information of FIG. 4, illustrating a process of transferring vendor data based on the validated anonymized consumer data.

FIG. 6A is a relationship diagram of the system for facilitating anonymized and transparent exchange of information of FIG. 4, illustrating an authorized release of identifying consumer data, according to one embodiment.

FIG. 6B is a relationship diagram of the system for facilitating anonymized and transparent exchange of information of FIG. 4, illustrating an authorized release of identifying consumer data, according to another embodiment.

FIG. 7 is a relationship diagram of a system for facilitating anonymized and transparent exchange of information, according to another embodiment of the present disclosure, utilizing radio frequency identification (RFID) technology and illustrating a process of receiving consumer data and transferring validated anonymized consumer data.

FIG. 8 is a user interface of a consumer portal of a system for facilitating anonymized and transparent exchange of information, according to one embodiment of the present disclosure.

FIG. 9 is another user interface of a consumer portal of a system for facilitating anonymized and transparent exchange of information, according to one embodiment of the present disclosure.

FIG. 10 is a user interface of a vendor portal of a system for facilitating anonymized and transparent exchange of information, according to one embodiment of the present disclosure.

FIG. 11A is a user interface of a vendor portal of a system for facilitating anonymized and transparent exchange of information, according to one embodiment of the present disclosure.

FIG. 11B is the user interface of the vendor portal of FIG. 11A displaying consumer data of a selected consumer profile.

FIG. 12 is a flow diagram of a method of anonymized transparent exchange of information, according to one embodiment.

FIG. 13 is a flow diagram of a method of anonymized transparent exchange of information, according to another embodiment.

### DETAILED DESCRIPTION

Information exchange presently is hampered by concerns of potential parties to an exchange as to how transferred information might be used. An acute example is the information exchange process preparatory to entering into an engagement with a financial service for a financial transaction. The information to be exchanged may include sensitive identifying information and/or proprietary information, which can be difficult to share with an unfamiliar other party who has not yet earned trust and confidence.

Consequently, parties exchanging information proceed with trepidation, often adopting a multistep approach that involves multiple partial exchanges as the parties gain familiarity and trust with each other and gather increasing levels of information. The repeated back and forth to request and transfer information can draw out and significantly prolong exchanges of information.

Systems and methods for providing anonymous, transparent exchanges of information can expedite accurate information sharing. The disclosed systems and methods empower parties to exchange information with desired anonymity and accuracy that can dramatically expedite exchanges over presently available systems and methods.

As one example, presently a consumer seeking financial services (e.g., a loan) may be reluctant to share identifying and/or sensitive financial information with an unfamiliar vendor due to concerns about how the vendor may use the information, whether the consumer will like working with the vendor, and general concerns about privacy and protection of identity. The consumer may be wary that, in the future, the information may be used to advertise additional products or otherwise solicit additional business from the consumer, which may be undesirable to the consumer. Or the consumer may be concerned whether the vendor is the “right” vendor. Based on these concerns, the consumer may prefer to retain identifying information (and thus not seek a price quote), rather than divulge the identifying or otherwise sensitive information in exchange for the quote.

On the flip side, vendors face a similar feeling of apprehension about providing proprietary data, such as terms of an offer to provide services (e.g., financial services), to unfamiliar consumers. A vendor may be reluctant to provide definite terms without knowing who the consumer is, including the credit history, income, and other information regarding ability to repay the loan. The vendor simply cannot assess the risk of lending to a consumer without certain information about the consumer. To divulge potential terms based on unsubstantiated information is to risk attracting an undesirable consumer and turning away a desirable consumer. Even where such risk is not a factor, the vendor may simply lack ability to guarantee terms without substantiated information.

A loan application or other lending or debt scenario (e.g, a mortgage) may benefit from and be expedited by anonymous transparent exchange of accurate information. Presently, preparation leading up to these types of a financial transaction can take days and weeks, as multiple exchanges of information are typical and underwriting to confirm accuracy of the information can then take days and weeks, prolonging a completion of the transaction for days and even weeks.

Disclosed systems and methods may be desirable to reduce application preparation and processing times. A potential consumer (e.g., borrower) and a potential vendor (e.g., lender) can analyze or otherwise consider a potential transaction with more complete and accurate information in a shorter amount of time. Underwriting, diligence, or other consideration of a potential transaction can be expedited with efficient and accurate exchange of complete and previously verified or otherwise validated information.

A purchase or sale of a business may be another interaction involving transfer of information that may be expedited by anonymous transparent exchange of accurate information. A potential seller or acquirer may wish to remain anonymous while shopping a potential transaction. Disclosed systems and methods for providing anonymous transparent exchanges of information can expedite and enable accurate information sharing preparatory to, or to otherwise facilitate, such a transaction.

A purchase or sale of an asset, such as real estate, intellectual property, inventory, or simply goods, is another interaction involving transfer of information that may be expedited by anonymous transparent exchange of accurate information. A potential seller or acquirer may wish to remain anonymous while exploring a potential transaction. Disclosed systems and methods for providing anonymous, transparent exchanges of information can expedite and enable accurate information sharing preparatory to, or to otherwise facilitate, such a transaction. Diligence, analysis, or other consideration of a potential transaction may be expedited by an efficient and accurate exchange of information.

Employment applications may be another situation where anonymous, yet transparent, sharing of information may expedite information exchange. An individual may wish to provide information to a potential employer to determine whether a job opportunity may be available. However, the potential applicant may prefer to remain anonymous about the inquiry. Similarly, a potential employer may be unable to provide specific details of an employment opportunity without more complete information about a potential applicant. Disclosed systems and methods for providing anonymous, transparent exchanges of information can expedite accurate information sharing such that a potential employee and a potential employer can analyze or otherwise consider an employment opportunity with more complete and accurate information in a shorter amount of time. Disclosed systems and methods may be desirable to reduce application (e.g., job application) preparation and consideration or processing times.

Exchanges of health information, such as for seeking medical insurance, may be another situation where anonymous, yet transparent, sharing of information may expedite information exchange. An individual may wish to provide information to a potential health insurer to request a quote for insurance. However, the potential applicant may prefer to remain anonymous about the inquiry. Similarly, a potential insurer may find it difficult to provide an accurate estimate of the cost of a medical insurance policy without having medical information of the individual(s) to be insured. Disclosed systems and methods for providing anonymous, transparent exchanges of information can expedite accurate information sharing such that an individual and a potential medical insurer can analyze or otherwise consider a medical insurance policy with more complete and accurate information in a shorter amount of time, and in compliance with the Health Insurance Portability and Accountability Act of 1996 (HIPAA). Disclosed systems and methods may be desirable to reduce application preparation and processing times.

Still other areas that anonymous, yet transparent, sharing of information may expedite information exchange and may be beneficial include post-secondary education applications (e.g., colleges and universities, technical schools, and trade schools); legal, accounting, and other professional services (to address conflicts or, suitability of clients); applications for licenses with regulatory authorities (to anonymously assess likelihood of obtaining license); and any other exchange of information where accuracy and/or anonymity may be desirable and/or beneficial.

The present disclosure will be better understood from the detailed description provided below and from the drawings of various embodiments, methods, and examples herein. These specifics, however, are provided for explanatory purposes that help the various embodiments of the disclosure to be better understood. The invention should therefore not be limited by the described embodiments, methods, and examples, but by all embodiments and methods within the scope and spirit of the invention as claimed.

The term “identifying consumer data” is used herein to refer to consumer data and/or information unique to a consumer's identity that is capable of identifying and/or enabling communication with the consumer, such as enabling a vendor to make unsolicited offers to the consumer. For example, a consumer's identifying data may include his or her name, Social Security identification number, street address, mailing address, telephone number, employment information, and/or any other information that may uniquely identify the consumer. Alternatively, the term “anonymized consumer data” is used herein to refer to consumer data and/or information that is not capable of uniquely identifying the consumer, but that is nevertheless specific to the consumer. For example, an anonymized consumer's data may include a consumer's monthly income, tax information, tax return data, bank account balance(s), credit card balances and limits, city, state, zip code, area code, age, and/or other data that does not uniquely identify the consumer so as to enable unsolicited communication with the vendor. In some embodiments, identifying consumer data may be referred to as “private data,” because it may be considered to remain private to the consumer until released by the consumer, and anonymized consumer data may be referred to as “public data,” because it is publicly accessible to users of the network (e.g., embodiments disclosed in U.S. Provisional Patent Application No. 62/155,371, titled SYSTEMS AND METHODS FOR ANONYMIZED TRANSPARENT TRANSACTIONS, filed Apr. 30, 2015).

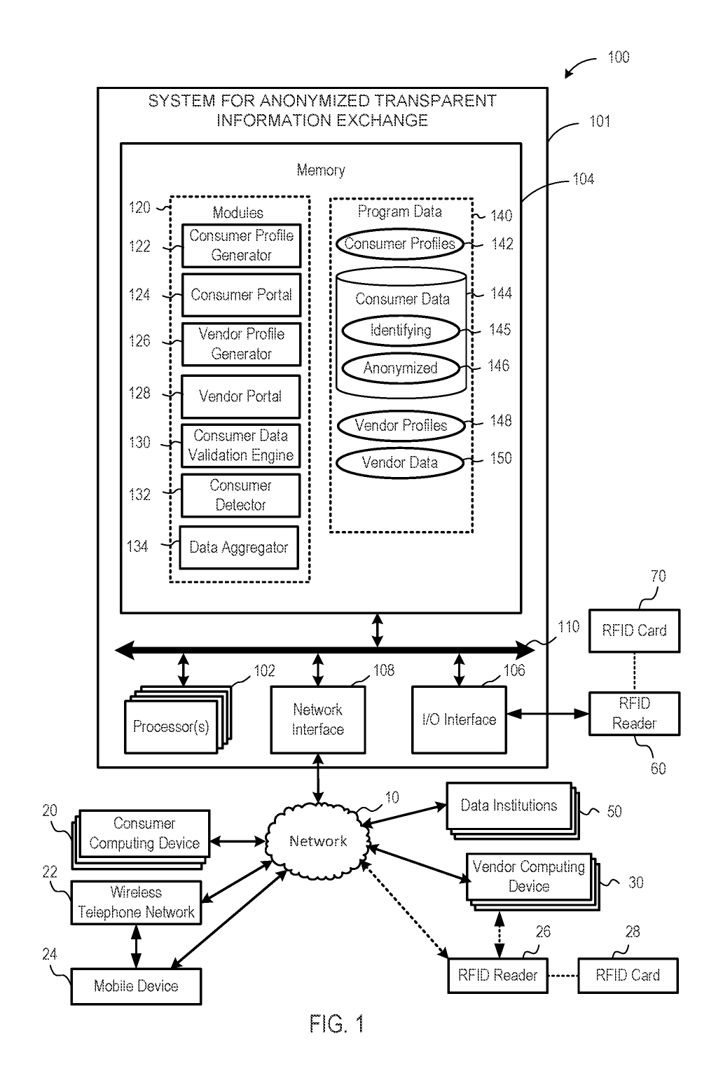

FIG. 1 is a block diagram illustrating a system architecture 100 for facilitating anonymized and transparent exchange of accurate information, according to one embodiment of the present disclosure. The system architecture 100 of FIG. 1 includes a central computing system 101 for anonymized transparent exchange of information, which communicates over a network 10 with consumer computing devices 20, vendor computing devices 30, and data institutions 50. The system architecture 100 facilitates information exchange through the system 101, which receives consumer data 144 from consumers via the consumer computing devices 20 and vendor data 150 from vendors via the vendor computing devices 30. The system 101 may validate received consumer data 144 with the data institutions 50 (e.g., government data and/or regulatory institutions such as the Internal Revenue Service, depository institutions, certified credit bureaus, higher education institutions, and public record institutions), which can give vendors greater assurance and/or confidence that they are exchanging accurate information with actual consumers. In addition, the system architecture 100 for facilitating anonymized transparent exchange of information may include or interface with a wireless telephone network 22 to allow consumer and/or vendor interface via a smart phone or other mobile device 24. The system architecture 100 may also include radio frequency identification (RFID) readers 26, 60 and RFID cards 28, 70 to automatically detect consumers and transfer corresponding anonymized consumer data 144 to one or more vendors.

The system 101 for anonymized transparent exchange of information includes one or more processors 102, an electronic memory 104, an I/O interface 106, a network interface 108, and a system bus 110. The system 101 of FIG. 1 provides anonymized transparent exchange of information preparatory to, or to otherwise facilitate, financial transactions for financial services, such as home mortgage loans, auto loans, and other transactions involving or benefiting from credit approval and/or underwriting. The system 101 may also enable other anonymized transparent exchanges of information.

The one or more processors 102 may include one or more general purpose devices, such as an Intel®, AMD®, or other standard microprocessor. The one or more processors 102 may include a special purpose processing device, such as ASIC, SoC, SiP, FPGA, PAL, PLA, FPLA, PLD, or other customized or programmable device. The one or more processors 102 perform distributed (e.g., parallel) processing to execute or otherwise implement functionalities of the present embodiments. The one or more processors 102 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The electronic memory 104 may include static RAM, dynamic RAM, flash memory, one or more flip-flops, ROM, CD-ROM, DVD, disk, tape, or magnetic, optical, or other computer storage medium. The electronic memory 104 may include a plurality of program modules 120 and a program data 140. The electronic memory 104 may be local to the system 101 or may be remote from the system 101 and/or distributed over the network 10.

The program modules 120 may include all or portions of other elements of the system 101. The program modules 120 may run multiple operations concurrently or in parallel by or on the one or more processors 102. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein, may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like.

The program data 140 stored on the electronic memory 104 may include data generated by the system 101, such as by the program modules 120 or other modules. The stored program data 140 may be organized as one or more databases.

The I/O interface 106 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network interface 108 may facilitate communication with other computing devices and/or networks 10, such as the Internet and/or other computing and/or communications networks. The network interface 108 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 110 may facilitate communication and/or interaction between the other components of the system 101, including the one or more processors 102, the electronic memory 104, the I/O interface 106, and the network interface 108.

As noted, the system 101 includes various program modules 120 (or engines, elements, or components) to implement functionalities of the system 101 and to generate, access, and/or, manipulate the program data 140 stored in the electronic memory 104. The system modules can include a consumer profile generator 122, a consumer portal 124, a vendor profile generator 126, a vendor portal 128, a consumer data validation engine 130, a consumer detector 132, and a data aggregator 134. The program data 140 can include consumer profiles 142, consumer data 144 (including identifying consumer data 145 and anonymized consumer data 146), vendor profiles 148, and vendor data 150.

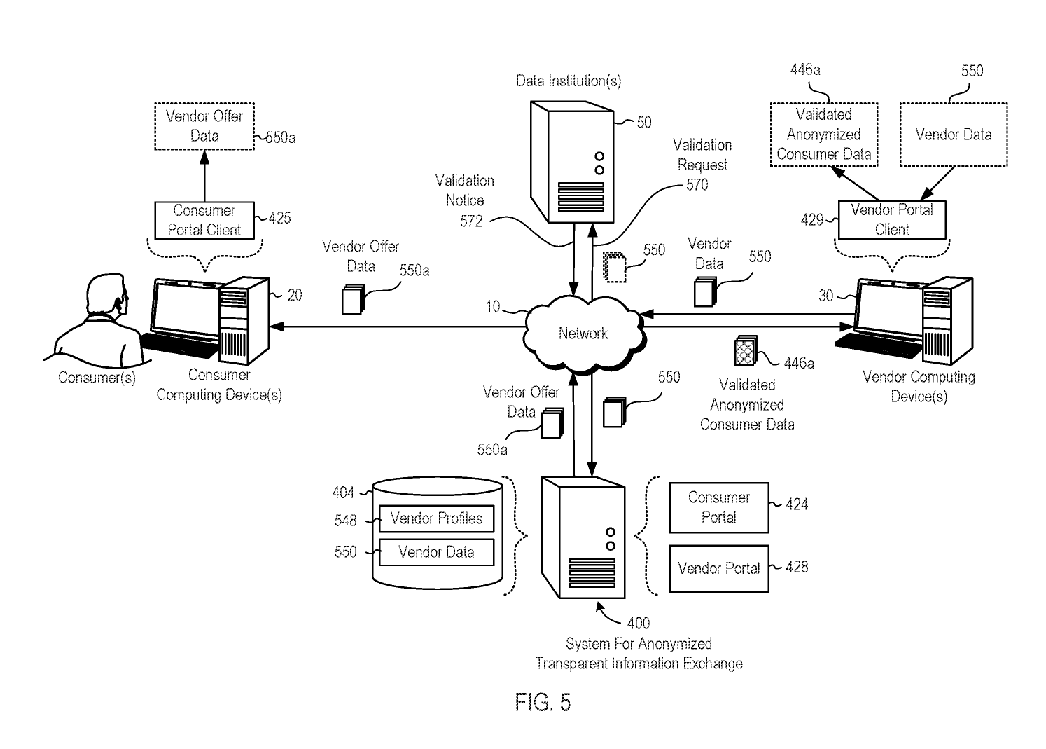

The consumer profile generator 122 may use consumer data 144, and specifically consumer profile data (e.g., login name and password), to create a consumer profile 142 for a consumer. The consumer profiles 142 created by the consumer profile generator 122 can contain, include, or otherwise associate consumer data 144 that is stored as program data 140 in the electronic memory 104. The consumer profile generator 122 may also generate and/or receive a consumer token to be stored with a consumer profile 142. The consumer token may provide a transportable or otherwise deliverable mechanism for a consumer to authorize release of identifying consumer data 145 of the consumer profile 142. The consumer may deliver the token to a vendor, for example, to authorize the vendor to request or otherwise access the identifying consumer data 145 of the consumer profile 142. The consumer token may include one or more of a pin number, a password, a reference number, a magnetic card, a dongle, and/or an RFID chip (as may be observed in the embodiment of FIG. 5).

The consumer portal 124 may provide a user interface that enables a consumer to interface with the system 101. Using the consumer portal 124, a consumer may request that a consumer profile 142 be generated by the consumer profile generator 122. Further, the consumer may utilize the consumer portal 124 to upload consumer data 144 to the system 101 to be stored in the electronic memory 104. The system 101 may receive the consumer data 144 through the I/O interface 106, the network interface 108, and/or, any other suitable interface. For example, a consumer may access the consumer portal 124 and the profile generator 122 with the consumer computing device 20 in electrical communication with the system 101 over the network 10. The consumer profile 142 that is generated may include at least a portion of the consumer data 144 uploaded to the system 101.

In certain embodiments, the consumer portal 124 may include or simply interface with a consumer portal client operating on the consumer computing device 20 of a consumer. In certain embodiments, the consumer portal 124 and/or the system 101 may provide the consumer portal client for installation on the remote consumer computing device 20. The consumer portal client may include a web browser presenting a web page that includes a user interface of the consumer portal 124. The web browser may be a program that permits a user to access various web servers, including content providers. The web browser may include the Microsoft® Internet Explorer web browser, the Google® Chrome web browser, the Apple® Safari web browser, or the like; however, other types of access software may also be used to implement a web browser, such as, for example, other types of Internet browsers, mobile applications (apps), customer network browsers, two-way communications software, cable modem software, point-to-point software, and the like.

The system 101, and specifically the consumer portal 124, may sort the consumer data 144 into, or otherwise designate, a portion of the consumer data 144 as identifying consumer data 145 and anonymized consumer data 146.

The identifying consumer data 145 may include any data enabling determination of an identity of the consumer. For example, the identifying consumer data 145 may include one or more of a name of the consumer, a phone number, an address, a Social Security number, an identification number, an employee identification number, a deposit account number, a credit card number, an email address, and/or a social media account.

The anonymized consumer data 146 may include data incapable of uniquely identifying the consumer. For example, the anonymized consumer data 146 may include one or more of tax return information with identifying information redacted, a deposit account balance, a credit score, employment information, monthly income, monthly debts, and city, county, state, country, and/or zip code of residence. The anonymized consumer data 146 can comprise both public data (e.g., public consumer data) that is publicly available and non-public data (e.g., non-public consumer data) that is obtained only from a non-public data source.

The consumer portal 124 may enable a consumer to review and/or browse vendor data 150 of one or more vendors. For example, the consumer may wish to view vendor offers. The consumer may use the consumer portal 124 to select a vendor and view vendor data 150 (and specifically vendor offer data) to aid in determining whether to accept or decline one or more vender offers of the selected vendor.

The vendor profile generator 126 may use vendor data 150 to create a vendor profile 148 for a vendor. The vendor profile 148 created by the vendor profile generator 126 can contain, include, or otherwise associate vendor data 150 that is stored as program data 140 in the electronic memory 104. The vendor data 150 associated with the vendor profile 148 may include vendor offer data, such as offer terms. The offer terms may vary according to criteria met by the consumer. The criteria may be specified in the vendor profile 148.

The vendor portal 128 may enable a vendor to request a vendor profile 148, access anonymized consumer data 146, use a consumer token to download identifying consumer data 145, aggregate anonymized data 146 via the data aggregator 134, and/or modify a vendor profile 148. Utilizing the vendor portal 128, a vendor may request creation of a vendor profile 148 by the vendor profile generator 126. Once a vendor profile 148 is created a vendor may upload vendor data 150 (e.g., vendor offer data) for the vendor profile 148. Vendor data 150 may include one or more of vendor offer data, past vendor offers, current vendor offers, received consumer tokens or other authorization to access identifying consumer data 145, vendor preferences, and/or aggregated anonymized consumer data 146. The system 101 may receive the vendor data 150 via the I/O interface 106, the network interface 108, and/or any other suitable interface. For example, the system 101 may receive vendor data 150 from the vendor computing device 30 in electrical communication with the system 101 via the network 10. The vendor profiles 148 may include at least a portion of vendor data 150 uploaded to the system 101. In certain embodiments, the vendor portal 128 may include, or interface with, a vendor portal client operating on the vendor computing device 30 of a vendor. In certain embodiments, the vendor portal 128 and/or the system 101 may provide the vendor portal client for installation on the remote vendor computing device 30. The vendor portal client may include a web browser presenting a web page including a user interface of the vendor portal 128.

Additionally, the vendor portal 128 may enable a vendor to provide vendor offer data to the consumer, based on the anonymized consumer data 146 for the consumer profile 142. The vendor offer data provided to the consumer may present and/or include an offer of one or more financial services. The offer of financial services may include one or more of a mortgage, an auto loan, a line of credit, a credit card, and an insurance policy. With access to anonymized consumer data 144, the vendor can present offer details and terms applicable to the actual consumer. In other words, a vendor may utilize the system 101 to present an offer to a consumer with vendor offer data determined according to the validated anonymized consumer data 146 of a corresponding consumer profile 142, despite not knowing the identity of the consumer. As a result, the vendor offer data (e.g., interest rate, credit limit, and/or terms of repayment) may reflect accurate terms of a future or potential transaction that the consumer may agree to enter into. The ability of the consumer to provide consumer data 144 in advance, and the ability of the vendor to make an offer with terms based off validated information available in the anonymized consumer data 146 can significantly expedite preparation for a financial transaction. The parties (e.g., the vendor and the consumer) can reach agreement on the terms of the transaction with a single exchange of information expedited by the system 101.

With authorization from the consumer, the vendor portal 128 may enable a vendor to view identifying consumer data 145 for the consumer profiles 142. As one example, the vendor portal 128 may enable a vendor to use a consumer token to demonstrate consumer authorization and thereby gain access to identifying consumer data 145 of the consumer profile 142. In certain embodiments the token may be received directly from the consumer, such as by hand delivery, over the phone, via an email or other message or courier service. In other embodiments, the token may be received electronically through the vendor portal 128. The vendor can then use the token, via the vendor portal 128, to obtain identifying consumer data 145 of a consumer. The consumer may have determined to agree to terms of an offer. The ability of the consumer to grant the vendor near immediate access to the identifying consumer data 145 can allow the vendor to expedite completion of documentation for closing on the transaction. As the transfer of identifying consumer data 145 to the vendor can be seamless and in essence immediate, the exchange of information and preparation for closure of a transaction is greatly expedited compared to presently common processes and systems.

In other situations and circumstances, a vendor may desire to gather data about customers, potential customers, or another target group of people. The data aggregator 134 may track and/or aggregate anonymized consumer data 146 based on one or more relevant tracking criteria. Relevant tracking criteria may include visiting a vendor's location (e.g., a store) or website, closing/accepting a vendor offer, income information, age, and any other relevant consumer characteristic. Through the vendor portal 128, a vendor may set tracking criteria. Alternatively, or in addition, the vendor portal 128 may enable a vendor to mine aggregated consumer data 144 to identify patterns and trends, and otherwise gain insight as to a customer base, a potential customer base, or other collection of people.

The vendor portal 128 may be further configured to enable the vendor to provide vendor offer data to one or more consumers, based on aggregated anonymized consumer data 146 from the consumer profiles 142. A set of consumer profiles 142 may be selected according to criteria and/or rules provided by the vendor through the vendor portal 128. More specifically, a vendor offer to a consumer may be prepared based on the anonymized consumer data 146 validated by one or more data institutions 50, such as validated monthly income, account balances, and/or a credit score. The vendor portal 128 may then automatically deliver vendor offer data to, or for presentation to, the consumers of the set of selected consumer profiles 142. A set of consumer profiles 142 may also be selected as corresponding to one or more consumers detected by the consumer detector 132 (e.g., detected by an RFID reader), as will be described. The vendor portal 128 may then automatically deliver vendor offer data to or for presentation to the detected consumers of the set of selected consumer profiles 142.

The consumer data validation engine 130 coordinates communications with third-party data institutions 50. Examples of data institutions 50 may include, but are not limited to, the Internal Revenue Service (IRS), depository institutions, certified credit bureaus, higher education institutions, public record institutions, and the like. If a consumer provides tax return information to the consumer portal 124, the consumer data validation engine 130 may request one or more relevant verification forms from the IRS, such as IRS Form 4506-T, to validate the tax information provided in the consumer data 144. If the consumer provides deposit account balances in the consumer data 144 provided to the consumer portal 124, the consumer data validation engine 130 may request validation from a depository institution. The consumer data validation engine 130 may interface with credit bureaus to validate credit score consumer data, with higher education institutions to validate educational history (e.g., transcripts, GPA, and degrees), and with public record institutions to validate ownership of property (e.g., county record records for real property and Uniform Commercial Code filings for goods).

Validation by the consumer data validation engine 130 may include gathering third-party data that may suggest or provide reasonable probability that the consumer data 144 received at the consumer portal 124 is accurate and correct. A validation may include receiving a validation notice, which may include a factual representation, in an electronic format, from a third-party that a piece or portion of consumer data 144 is accurate and/or correct. A desired level or standard of factual representation for confirming accuracy and/or correctness may depend on circumstances and may fluctuate and vary. In other words, validation may include receiving a communication from a third-party data institution that suggests a portion of consumer data 144 is plausibly correct, and does not require certainty as to the accuracy and/or correctness of any consumer data, such as a side-by-side comparison with an official document. For example, an electronic communication from a depository institution confirming an individual holds an account with a balance within a range may be sufficient for validation. An electronic communication from a university providing a graduate's grade point average (GPA), degree, and graduation year may be sufficient. An electronic communication from an employment database confirming a consumer's employer and an approximate salary may be sufficient validation. Validation can also include more stringent standards, such as a verification of precise accuracy and correctness of the consumer data, such as by a comparison with an official document or verification by an authorized official. For example, an electronic copy of a bank statement received from a banking institution may provide verification of bank account consumer data. A copy of a university transcript with a stamp, watermark, digital signature or other security feature ensuring authenticity may provide verification of education consumer data. A pay stub may provide verification of employment and income consumer data. In short, validation as used herein can encompass all types of third-party corroboration, confirmation, and even verification as to the accuracy and/or correctness of a piece or portion of consumer data provided by a consumer.

As can be appreciated, the consumer data validation engine 130 may be implemented in or integrated with one or more other components of the system 101. For example, in other embodiments, the consumer portal 124 and/or the vendor portal 128 may include the consumer data validation engine 130.

In certain embodiments, the consumer portal 124, upon receiving consumer data 144, may automatically alert the consumer data validation engine 130 to generate and transmit a validation request. The consumer data validation engine 130 may generate the validation request to package at least a portion of the consumer data 144 received for transmitting to the data institution(s) and to specify a level of validation or requirements for validation (e.g., verification, corroborating evidence, statement). The validation request may then be automatically transmitted to the data institutions 50 over the network 10 by the network interface.

In certain embodiments, upon receiving validated consumer data 144 from the data institutions, the consumer data validation engine 130 may automatically alert the consumer portal 124 of the receipt of the validated consumer data 144. The consumer portal 124 may automatically alert the vendor portal 128 of the arrival of the availability of the validated anonymized consumer data 146 for the consumer, such that the vendor portal 128 can facilitate generation of vendor offers based on the validated anonymized consumer data 146.

The consumer detector 132 may detect presence of a consumer at a location. In a physical setting, the consumer detector 132 may include or couple to a physical presence detector, such as the RFID reader 60, that can detect a consumer (e.g., an RFID card or chip) at a physical location, such as a vendor's retail store. When a consumer is detected in a physical location, the consumer detector 132 may request, access, or otherwise send notification regarding a corresponding consumer profile 142, such that the anonymized consumer data 146 of the consumer profile 142 can be retrieved, such as for use by the vendor or for aggregation by the data aggregator 134.

The consumer detector 132 may also enable detection of a consumer in a virtual location or space, such as visiting the vendor's website, another website, a social media platform, and the like. The consumer detector 132 may be a page view detector (or Internet reader), which may include one or more of a browser plugin, cookies, and/or a web tracker or visit tracker to detect when a consumer is in a virtual location. The consumer detector 132 may in turn request, access, or otherwise send notification regarding a corresponding consumer profile 142, such that the anonymized consumer data 146 of the consumer profile 142 can be retrieved for the vendor. For example, the consumer profile 142 may be retrieved for the vendor and aggregated with other consumer profiles 142 by the data aggregator 134.

The data aggregator 134 may track and aggregate consumer data 144, and more specifically consumer profiles 142 and associated consumer data 144, for detected consumers. The data aggregator 134 may aggregate consumer data 144 according to vendor pre-defined or otherwise configurable criteria or preferences. For example, the vendor may wish to understand more about individuals that fall into generation X or Y that visit the vendor's place of business. The data aggregator 134 can determine which consumer profiles 142 retrieved by the consumer detector 132 fit these criteria and can compile a data set to give the vendor insight as to the characteristics of these individuals. Generally the data aggregator 134 will only have access to anonymized consumer data 146 associated with a consumer profile 142. However, in some instances the consumer may have previously authorized release of identifying consumer data 145 to the vendor. In such instances, the data aggregator 134 may also aggregate identifying consumer data 145 with the anonymized consumer data 146. The consumer data 144 aggregated for a given vendor by the data aggregator 134 can be searched, mined, reported out, and the like to enable a vendor to gain insight on a target group of consumers and gain invaluable business intelligence. This business intelligence can be used by a vendor to devise future vendor offers targeting certain consumers. The vendor can utilize the vendor portal 128 to prepare and present offers for targeted groups of consumers, as previously described. In some embodiments, the data aggregator 134 aggregates consumer data 144 for a given vendor and stores the aggregated consumer data 144 in the program data 140. In other embodiments, the aggregated consumer data 144 is transmitted to, or otherwise delivered to the vendor computing device 30 or other for storage.

The data aggregator 134 may include a rules engine to process rules provided by a vendor to specify criteria for selecting consumers and vendor offer terms for consumers that meet those criteria. The rules may account for varying characteristics of consumers and define how vendor offer terms should vary according to the characteristics of the consumer. For example, a rule may specify that a consumer with a credit score above a certain level (e.g., above 730) will receive an offer with a first interest rate and/or a first set of fees, whereas a consumer with a credit score below the certain level will receive a second interest rate and/or a second set of fees. The data aggregator 134 with a rules engine can process rules and thereby enable the system 101 to automatically respond to consumer requests for offers with vendor offers that are specific to the consumer's characteristics.

In the embodiment of FIG. 1, the data aggregator 134 is implemented on the system 101 and the consumer data 144 is aggregated by the system 101 for storage in the program data 140 of the electronic memory 104. In other embodiments, the data aggregator 134 may be implemented on or by another component of the system 101, such as by a vendor portal client executing on the vendor computing device 30.

The system 101 for anonymized transparent exchange of information can enable a consumer to shop for goods and services with an anonymous yet validated identity. A consumer may shop with an anonymous transaction exchange (ATE) identity, which can notify vendors that the consumer's information is available and accurate by accessing the consumer anonymized data 146 of the consumer profile 142. The ATE identity also notifies vendors of a possibility of efficient and expedited transactions. In other words, a consumer shopping as “John Doe ATE” can have greater credibility and become eligible for significant privileges such as discounts and special offers as compared to shopping as merely “John Doe.” A consumer shopping through the system 101 as John Doe ATE can nearly instantaneously provide validated anonymized consumer data 146 to vendors to solicit or otherwise access vendor offers with actual terms for the consumer's characteristics, and also nearly instantaneously transfer identifying consumer data 145 to expedite closing of a desired transaction.

The system 101 for anonymized transparent exchange of information can enable a vendor to transact or otherwise interface with consumers more efficiently. The vendor, through the system 101, can obtain validated information about consumers in the form of validated anonymized consumer data 146, which provides previously unmatched market intelligence. Vendors using the system 101 can manually (e.g., an auto dealer closing an auto loan on-site) and automatically (e.g., responding to customer inquiries over the Internet) provide vendor offer terms more efficiently and more economically because the system 101 reduces significant effort and resources directed toward preparing offers based on hypothetical, inaccurate, or otherwise non-validated consumer information.

In short, the presently disclosed systems and methods can enable both consumers and vendors to transact more efficiently. The disclosed embodiments automatically integrate data inputs from multiple sources, including consumer data 144 provided by consumers via the consumer computing device 20 and/or validated consumer data as provided by data institutions 50. The disclosed embodiments can automatically process raw consumer data to anonymize and/or validate the information therein and thereby transform the consumer data to validated and/or anonymized consumer data that enables consumers and vendors to interface more efficiently. The raw consumer data can in essence be translated or otherwise transformed to an improved form for transacting. The disclosed embodiments also receive data input from vendors in the form of criteria and/or rules and can automatically process consumer anonymized data 146 according to the criteria and/or rules. Stated otherwise, the disclosed embodiments may automatically aggregate consumer anonymized data 146 and/or present vendor offer terms, based on the criteria and/or rules. The disclosed embodiments may handle automatic interactions with consumers based on consumer anonymized data 146 of the consumers, as described more fully below.

FIG. 2 is block diagram of a consumer portal 200 of a system for facilitating anonymized and transparent exchange of information, according to one embodiment of the present disclosure. The consumer portal 200 may be similar to or analogous to the consumer portal 124 of FIG. 1. The consumer portal 200 may include a consumer user interface 202, a consumer data engine 204, a release and authorization engine 206, and an offer review engine 208.

The consumer user interface 202 can enable a consumer to interface with a system for facilitating anonymized and transparent exchange of information, and more specifically with the consumer portal 200. The consumer user interface 202 may provide functionality or otherwise enable a consumer to interface by creating a consumer profile, uploading or otherwise providing consumer data, and reviewing and/or browsing vendor data from one or more vendors. The consumer may provide profile information via the consumer user interface 202. The consumer may also provide consumer data via the consumer user interface 202, such as by uploading documents, entering information, and requesting information from third-party sources. For example, the consumer user interface 202 may enable a consumer to upload pay stubs, tax returns, bank statements, utility bills, and the like in preparation for a financial transaction. The consumer may also provide direction or command via the consumer user interface 202 for the consumer data validation engine 210 to validate consumer data provided by the consumer with a third party or to request supplemental consumer data from a third party.

The consumer user interface 202 may also enable a consumer to control release of consumer data. The consumer user interface 202 may enable a consumer to determine whether to release anonymized consumer data for vendors (specific vendors or vendors generally) to view or otherwise access. The consumer user interface 202 may also enable a consumer to authorize release of identifying consumer data, such as to a specific vendor. In certain embodiments, the consumer user interface 202 may enable the consumer to communicate a token to a vendor. The token may be used by the vendor to access identifying consumer data of a profile of the consumer. The consumer may authorize the release of identifying consumer data, such as via delivery of a token, to further preparation for a transaction, as a final step of preparation for a transaction, and/or as an act of accepting an offer of a vendor.

In certain embodiments, the consumer user interface 202 may be served or otherwise provided to a consumer portal client operating on a client computing device. The consumer portal client may include a web browser presenting a web page including the consumer user interface 202.

The consumer data engine 204 may process the consumer data received via the consumer user interface 202 and/or from the consumer data validation engine 210. The consumer data engine 204 may parse, sort, categorize, or otherwise separate identifying consumer data and anonymized consumer data.

The consumer data engine 204 may separate identifying consumer data by analyzing the consumer data to identify any consumer data that may enable determination of an identity of the consumer. For example, the consumer data engine 204 may designate one or more of a name of the consumer, a phone number, an address, a Social Security number, an identification number, an employee identification number, a deposit account number, a credit card number, an email address, and/or a social media account as identifying consumer data.

The consumer data engine 204 may also determine anonymized consumer data by redacting or otherwise removing the identifying consumer data from the consumer data received. In other words, the consumer data may be processed to extract or otherwise remove identifying consumer data to leave anonymized consumer data, such that the identifying consumer data is separated from the anonymized consumer data. The anonymized consumer data may include data incapable of uniquely identifying the consumer. For example, the anonymized consumer data may include one or more of tax return information (e.g., tax bracket, taxable income, gross income, taxes due, etc.) with identifying information extracted or otherwise redacted, a deposit account balance, a credit score, employment information, monthly income, debts owed or other liabilities, and city, county, state, country, and/or zip code of residence. The anonymized consumer data may be data that remains after extraction or separation of identifying consumer data. In other embodiments, excess consumer data may remain and/or be discarded or otherwise not included in the identifying consumer data and anonymized consumer data. In other words, the identifying consumer data combined with the anonymized consumer data may be a portion of the consumer data.

The release and authorization engine 206 may provide access control functionality to ensure that a consumer maintains a measure of control of how consumer data is released to vendors. In certain embodiments, a consumer has no control over release of anonymized consumer data; vendors with access to the system have access to all anonymized consumer data of all consumer registered with the system. In certain embodiments, the release and authorization engine 206 enables a consumer to maintain control of when, how, and to whom anonymized consumer data is released.

The release and authorization engine 206 tracks and maintains authorization and/or rights of vendors to access identifying consumer data. The release and authorization engine 206 may facilitate and or participate in generation of a token by the consumer profile generator to be stored with a consumer profile. The release and authorization engine 206 may facilitate delivery of tokens. The release and authorization engine 206 may track tokens, including confirmation of use of a token by an intended vendor, number of uses of a given token, and/or expiration of a token. The release and authorization engine 206 may track tokens from a consumer perspective to ensure proper handling and/or management of consumer tokens by vendors.

The offer review engine 208 may enable a consumer to review and/or browse vendor data of one or more vendors, and particularly vendor offer data. For example, the consumer may wish to view vendor offers. The offer review engine 208 of the consumer portal 200 may facilitate consumer searching, selection, and/or filtering of vendor data to select a vendor and view vendor data (and specifically vendor offer data). A consumer may provide criteria (e.g., search terms) for finding and/or selecting desirable vendors and/or vendor offer data. A consumer may also configure filters, rules, or the like to automatically evaluate vendor data and/or vendor offer data for determining whether to present the vendor data and/or vendor offer data to the consumer.

As can be appreciated, any of the elements, functionalities, modules, and/or components of the consumer portal 200 may be partially or fully implemented by other components of a system for anonymized transparent exchange of information, or combined in a different manner to accomplish the described tasks, objectives, and/or functions.

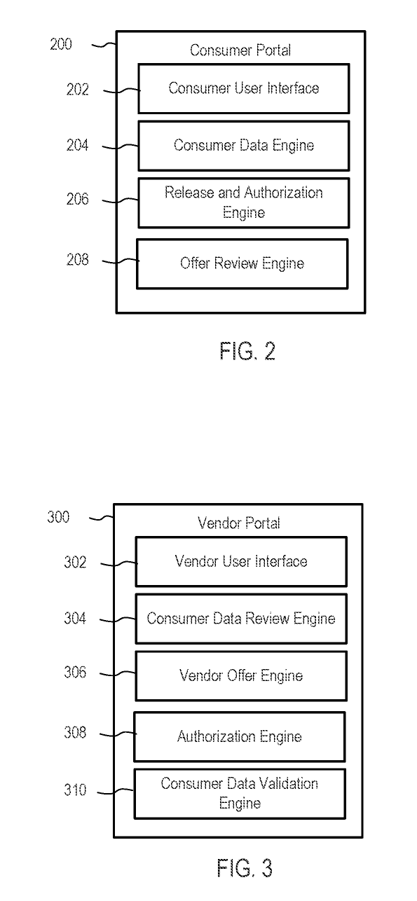

FIG. 3 is block diagram of a vendor portal 300 of a system for facilitating anonymized and transparent exchange of information, according to one embodiment of the present disclosure. The vendor portal 300 may be similar to or analogous to the vendor portal 128 of FIG. 1. The vendor portal 300 may include a vendor user interface 202, a consumer data review engine 304, a vendor offer engine 306, an authorization engine 308, and a consumer data validation engine 310.

The vendor user interface 302 can enable a vendor to interface with a system for facilitating anonymized and transparent exchange of information, and more specifically with the vendor portal 300. The vendor user interface 302 may provide functionality or otherwise enable a vendor to interface by creating a vendor profile, accessing anonymized consumer data provided by consumers, demonstrating authorization to receive identifying consumer data, downloading or otherwise accessing authorized identifying consumer data, aggregating anonymized consumer data via a data aggregator, and/or modifying a vendor profile. Stated otherwise, the vendor user interface 302 may present or otherwise provide functionality to enable a vendor to input or otherwise provide vendor data (e.g., vendor offer data) that can be stored within or in association with a vendor profile. Vendor data may include one or more of vendor offer data, past vendor offers, current vendor offers, received consumer tokens, received authorization to access identifying consumer data, vendor preferences, and/or aggregated anonymized consumer data.

A vendor may provide profile information via the vendor user interface 302. The vendor may also provide vendor data, including offer criteria and vendor offer data, via the vendor user interface 302. The vendor user interface 302 may enable a vendor to provide offer criteria specifying conditions under which an offer, or given offer terms, is to be extended to a consumer. The offer criteria provide for vendor control or direction for automatic extending of offers. The offer criteria allow a vendor to determine in advance which types of consumers receive which offer terms. The vendor user interface 302 may also enable a vendor to provide vendor offer data to specify terms of potential offers to be extended to consumers. For example, a vendor may utilize the vendor user interface 302 to provide vendor offer data (e.g., terms of a loan) applicable for certain offer criteria (e.g., consumers with credit scores above a given level and income within a given range). A vendor profile may be generated or otherwise created using the profile information and vendor data.

The vendor user interface 302 may also enable a vendor to view anonymized consumer data. The vendor user interface 302 may provide for viewing anonymized consumer data for an individual consumer, such as a consumer that may have requested an offer or other information of the vendor. The vendor user interface 302 may present for a vendor the anonymized consumer data of a consumer, such that the vendor can reciprocate by providing vendor data that is based on the viewed consumer data. The vendor user interface 302 may also enable a vendor to view an aggregation of consumer data for a plurality of consumers. The vendor user interface 302 may enable mining of aggregated consumer data for analysis and generating business intelligence.

The vendor user interface 302 may also enable a vendor to provide a token or other type of evidence or demonstration of authorization to access identifying consumer data. The token may be one or more of a pin number, a password, and a reference number. The token may be transportable on one of a magnetic card, a dongle, and a radio frequency identification (RFID) chip. The token may be received by the vendor from an external source (e.g., a delivery mode external to the system for anonymized transparent exchange of information). In another embodiment, the token may be received via the vendor user interface 302, such as by secure message or a similar mechanism.

Upon demonstrating authorization to access identifying consumer data, the vendor user interface 302 may enable a vendor to download or otherwise access authorized identifying consumer data. The vendor user interface 302 may enable a vendor to view the identifying consumer data, similar to the anonymized consumer data.

In certain embodiments, the vendor user interface 302 may include and/or interface with a vendor portal client operating on a client computing device of a vendor. The vendor portal client may include a web browser presenting a web page including the vendor user interface 302 of the vendor portal 300.

The consumer data review engine 304 may process consumer data (e.g., individual and aggregated consumer data, including anonymized and/or identifying consumer data) for reporting and/or presentation to a vendor. In other words, the consumer data review engine 304 may provide compilation, organization, filtering, searching, mining, and the like for presenting consumer data via the vendor user interface 302. The consumer data review engine 304 may enable a vendor to identify and/or target a desired target consumer or group of consumers for presenting an offer for goods or services.

The vendor offer engine 306 can enable a vendor to provide vendor offer data to a consumer. The vendor offer engine 306 may receive and store vendor offer data received through the vendor user interface 302. The vendor offer data may specify terms of potential offers to be extended to consumers. The vendor offer engine 306 can also receive and store offer criteria specifying conditions under which an offer, or given offer terms, is to be extended to a consumer. The offer criteria provide for vendor control or direction for the vendor offer engine 306 to automatically generate and extend offers. The offer criteria allow a vendor to determine in advance which types of consumers receive which offer terms.

The vendor offer engine 306 evaluates consumer data associated with consumer profiles of, for example, detected consumers and/or consumers who release anonymized consumer data for viewing by vendors. The vendor offer engine 306 evaluates the consumer data based upon offer criteria provided by one or more vendors. Based on the evaluation, the vendor offer engine 306 may determine vendor offer data to be presented to one or more consumers. More specifically, the vendor offer engine 306 may identify vendor offer terms for a vendor offer to a consumer, based on results of evaluating consumer data against vendor offer criteria. The vendor offer engine 306 enables automatic generation of vendor offers that are crafted according to criteria of the one or more consumers to whom the vendor offers are delivered or otherwise presented. The vendor offer engine 306 may facilitate vendor searching, selection, and/or filtering of consumer data, and specifically anonymized consumer data to select and/or otherwise identify desirable consumers for presenting offers.

In one embodiment, the vendor offer data provided to the consumer may present and/or include an offer of one or more financial services. The offer of financial services may include one or more of a mortgage, an auto loan, a line of credit, a credit card, an insurance policy. With access to anonymized consumer data, the vendor can configure the vendor offer engine 306, or otherwise provide vendor offer data to the vendor offer engine 306, to present offer details and terms applicable to the actual consumer. In other words, the vendor offer engine 306 can present an offer to a consumer with vendor offer data determined according to the validated anonymized consumer data of a corresponding consumer profile, even though the identity of the consumer is unknown. As a result, the vendor offer data (e.g., interest rate, credit limit, and/or terms of repayment) that is presented may reflect accurate terms of a future transaction. In other words, the vendor offer engine 306 can, based on the anonymized consumer data, prepare offer terms or even an offer that the consumer may accept.

The authorization engine 308 manages a vendor's received authorization from consumer to access consumer data. The authorization engine 308 may manage checking and otherwise ensure a vendor has or obtains authorization to view anonymized consumer data, such as by determining that a consumer has released associated anonymized consumer data before the vendor portal 300 accesses the anonymized consumer data, including before vendor viewing of the anonymized consumer data via the vendor user interface 302, processing of the anonymized consumer data by the consumer data review engine 304, and evaluation of the anonymized consumer data by the vendor offer engine. 306.

The authorization engine 308 may also track and manage tokens received by a vendor for authorizing access to identifying consumer data. The authorization engine 308 may provide functionality for checking validity and determining authorization from a consumer granted by a token before the vendor portal 300 accesses identifying consumer data, including enabling vendor viewing of identifying consumer data via the vendor user interface 302. The authorization engine 308 may track tokens from a vendor perspective to ensure proper handling and/or management of consumer tokens by vendors.

With authorization from the consumer (e.g., using a consumer token of a consumer profile), the vendor portal 300 may allow a vendor to view or otherwise access identifying consumer data for a consumer profile. As the transfer of identifying consumer data to the vendor can be seamless and in essence immediate, the exchange of information and preparation for closure of a transaction is greatly expedited compared to present processes and systems.

The consumer data validation engine 310 can coordinate communications with third-party data institutions to validate consumer data. In certain embodiments, consumer data received via a consumer portal is validated upon a request from a vendor. In such embodiments, a vendor portal may receive a vendor request for validation of consumer data and coordinate validation with a third-party data institution. Examples of data institutions may include, but are not limited to, the Internal Revenue Service (IRS), depository institutions, certified credit bureaus, higher education institutions, public record institutions, and the like. If the consumer data includes tax return information, the consumer data validation engine 310 may request one or more relevant verification forms from the IRS, such as form 4506T, to validate the tax information provided in the consumer data. If the consumer data includes deposit account balances, the consumer data validation engine 310 may request validation from a depository institution. The consumer data validation engine 310 may interface with credit bureaus to validate credit score consumer data, with higher education institutions to validate educational history (e.g., transcripts, GPA, and degrees), and with public record institutions to validate ownership of property (e.g., county record records for real property and Uniform Commercial Code filings for goods). The consumer data validation engine 310 of the vendor portal 300 of FIG. 3 may be similar to or analogous to the consumer data validation engine 210 of the consumer portal 200 of FIG. 2 and may include similar features, elements, and/or functionality.

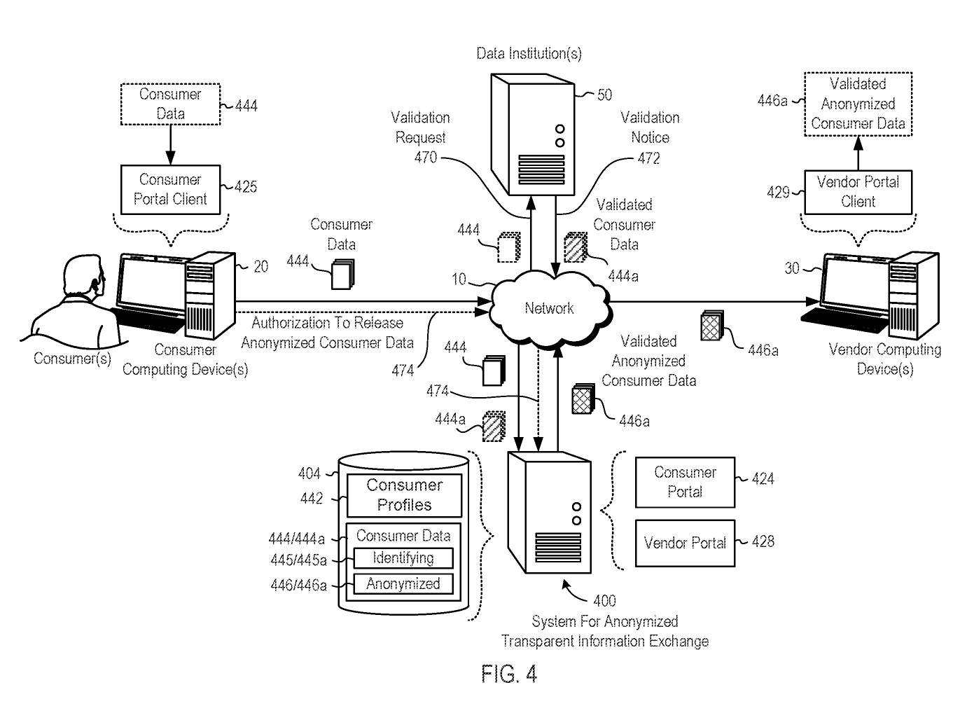

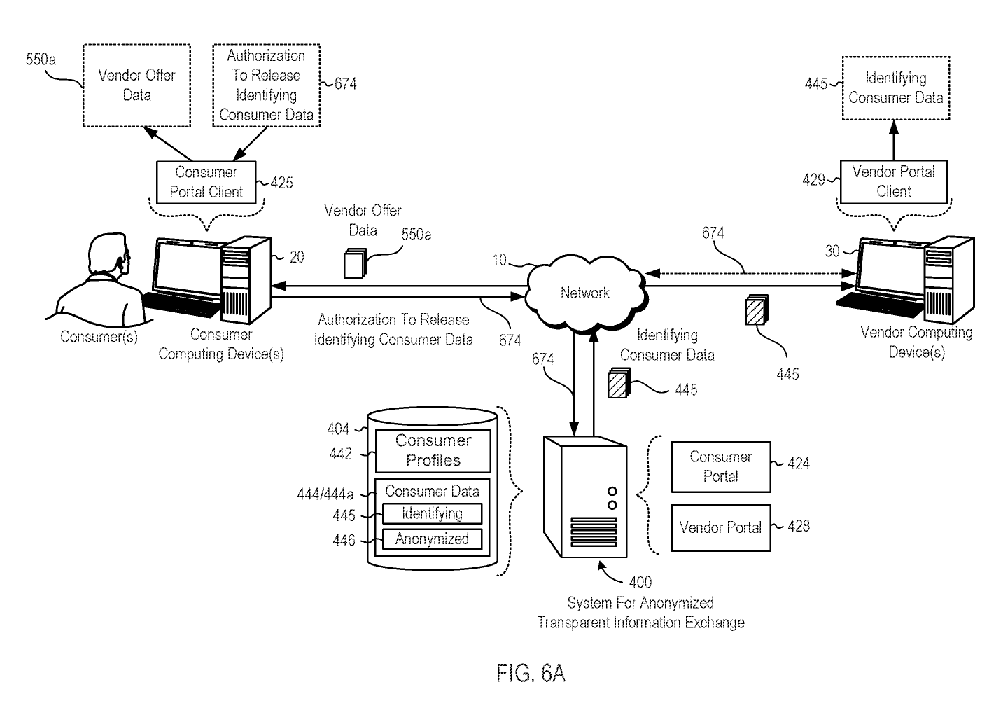

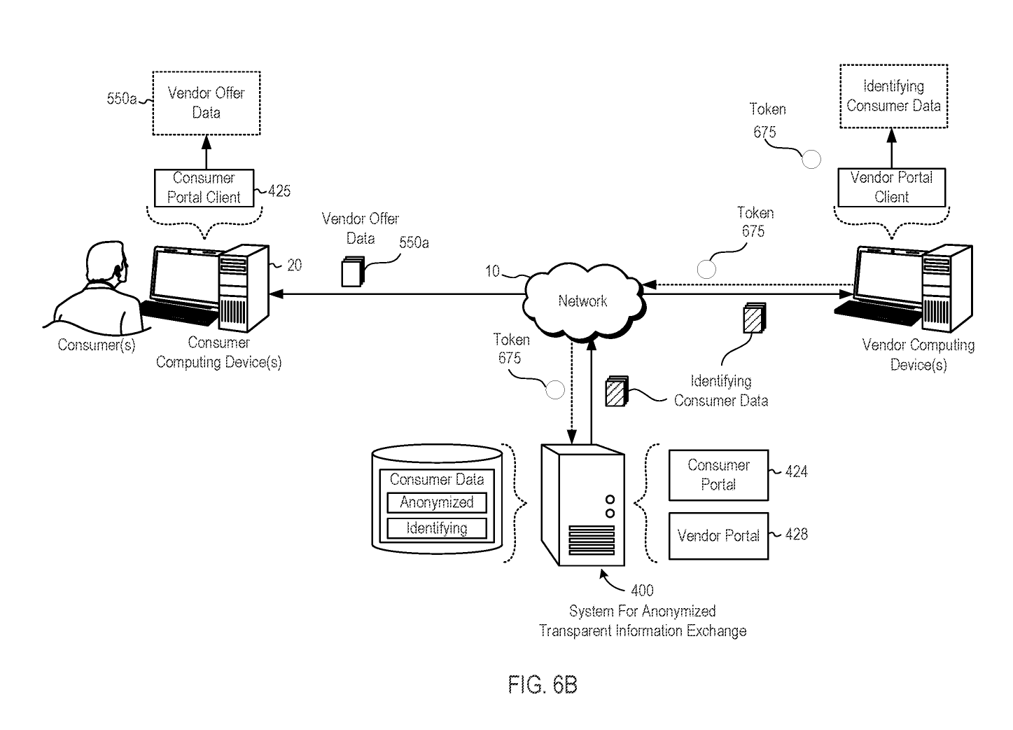

FIGS. 4, 5, 6A, and 6B are relationship diagrams of a system 400 for facilitating anonymized and transparent exchange of information, according to another embodiment of the present disclosure. These FIGS. 4, 5, 6A, and 6B illustrate various aspects of an anonymized transparent exchange of information facilitated by the system 400. FIG. 4 illustrates receipt of consumer data from a consumer and transfer of validated anonymized consumer data to a vendor. FIG. 5 illustrates a vendor transfer of vendor offer data based on validated anonymized consumer data. FIG. 6A illustrates one embodiment of an authorized release of identifying consumer data. FIG. 6B illustrates another embodiment of an authorized release of identifying consumer data.

Referring to FIGS. 4, 5, 6A, and 6B, generally and collectively, the system 400 may include a consumer portal 424, a vendor portal 428, and an electronic memory 404 to store consumer profiles 442 and consumer data 444, which is sorted or otherwise separated into identifying consumer data 445 and anonymized consumer data 446. The system 400 may be in electrical communication with a network 10, which may provide electrical communication between multiple computing devices, including a consumer computing device 20, a vendor computing device 30, and/or one or more data institutions 50. The network 10 between the system 400 and the computing devices 20, 30, 50 may allow the system 400 to send and receive various kinds of data to and from each of the computing devices 20, 30, 50. For example, a consumer may utilize a consumer portal client 425 on the consumer computing device 20 to interface with the consumer portal 424 of the system 400 to request creation or modification of a consumer profile 442 and/or to upload consumer data 444 for the consumer profile 442 to the system 400. As another example, a vendor may utilize a vendor portal client 429 on the vendor computing device 30 to interface with the vendor portal 428 of the system 400 to request creation or modification of a vendor profile 548 and/or to provide vendor data 550, which may include vendor offer data 550a, to a consumer. The system 400 facilitates anonymizing data (e.g., consumer data and/or vendor data), validating data, and/or exchanging data.

FIG. 4, specifically, illustrates receipt of consumer data 444 from a consumer at the system 400 and transfer of validated anonymized consumer data 446a to a vendor. A consumer may upload consumer data 444 to the system 400 by utilizing the consumer portal client 425 on the consumer computing device 20. In the case of preparing for a potential financial transaction, the consumer may upload consumer data 444 including, but not limited to, name, address, phone number, Social Security number, credit score, employment information, pay stubs, tax return(s), deposit account balances, title of assets, and statements of liabilities (e.g., debts, loans, and credit cards). Other examples of consumer data 444 may include post-secondary education transcripts (e.g., college, university, technical school, and trade school), diploma, statements of insurance, operating agreements, stock certificates, transfers or assignments of title, medical records, and licenses (or other regulatory approval).

The consumer portal client 425 of the consumer computing device 20 transfers the consumer data 444 over the network 10 to the consumer portal 424 of the system 400. In certain embodiments, the consumer portal 424 stores the received consumer data 444 in the electronic memory 404 of the system 400 in association with a consumer profile 442. The consumer portal 424, if a consumer profile 442 for the consumer does not exist, may also generate a consumer profile 442.

In the illustrated embodiment of FIG. 4, the consumer portal 424 may validate all or a portion of the consumer data 444 to better ensure accuracy of the consumer data 444 and thereby provide vendors with greater assurance of the accuracy of the consumer data 444 when transferring to vendors. In other embodiments, a consumer may request that the consumer portal 424 of the system 400 validate at least a portion of the consumer data 444. The consumer portal 424 may transmit, over the network 10, all or a portion of the consumer data 444 and/or a validation request 470 to a data institution 50. Examples of data institutions 50 include, but are not limited to, government data and/or regulatory institutions such as the IRS, depository institutions, certified credit bureaus, higher education institutions, and public record institutions. Complete documents (e.g., a tax return) of consumer data 444 may be transmitted to a data institution 50 for validation. Or a portion (e.g., a name and Social Security number) of consumer data 444 and/or a validation request 470 (e.g., IRS Form 4506-T) may be transmitted to the data institution 50.

In other embodiments, the vendor portal 428 may validate all or a portion of the consumer data 444 at a time of a vendor requesting access or otherwise seeking access to the consumer data 444. Validation of consumer data 444 can be initiated at various points during an anonymous transparent exchange of information.

The data institutions 50 receive the validation request 470 and/or the consumer data 444 and validate accuracy of the consumer data 444. The data institutions 50 can send validated consumer data 444a and/or a validation notice 470 to the system 400. In certain embodiments, the system 400 may validate consumer data 444 simply by downloading validated consumer data 444a from one or more data institutions 50.

The system 400 may receive validated consumer data 444a from the data institutions 50 and store the validated consumer data 444 in the electronic memory 404. As can be appreciated, in some embodiments, the system 400 stores raw or unvalidated consumer data 444 in the electronic memory 404 and also stores the validated consumer data 444a once received. In some embodiments, the system 400 stores raw or unvalidated consumer data 444 in the electronic memory 404 and then replaces or updates with the validated consumer data 444a once received. In some embodiments, the system 400 stores raw or unvalidated consumer data 444 in the electronic memory 404 and also stores an indication of which portions are validated and which portions are not validated, upon receipt of validated consumer data 444a. In some embodiments, the system 400 stores the consumer data 444, with any portions of validated consumer data 444a, upon receipt of a validation notice 472 or validated consumer data 444a. In short, any of a number of appropriate ways to store consumer data 444 and/or validated consumer data 444a are possible and may be implemented by the disclosed embodiments, to track consumer data 444 and which portions may be validated consumer data 444a to be able to provide vendors with appropriate assurance as to accuracy of any given portion of consumer data 444. As can be appreciated, the validated consumer data 444a can include both validated identifying consumer data 445a and validated anonymized consumer data 446a.

The system 400, and specifically the consumer portal 424, sorts the consumer data 444/444a into, or otherwise designates a portion of the consumer data 444/444a as, identifying consumer data 445/445a and anonymized consumer data 446/446a. As can be appreciated, the identifying consumer data 445 and/or the anonymized consumer data 446 may be unvalidated, validated, or a combination thereof, based on a stage or time at which the consumer data 444/444a is stored in electronic memory 404. The identifying consumer data 445 may include any data enabling determination of an identity of the consumer. For example, the identifying consumer data 445 may include one or more of a name of the consumer, a phone number, an address, a Social Security number, an identification number, an employee identification number, a deposit account number, a credit card number, an email address, and/or a social media account. The anonymized consumer data 446 may include data incapable of uniquely identifying the consumer. For example, the anonymized consumer data 446 may include one or more of tax return information with identifying information redacted, a deposit account balance, a credit score, employment information, monthly income, monthly debts, and city, county, state, country, and/or zip code of residence. The anonymized consumer data 446 can comprise both public data (e.g., public consumer data) that is publicly available and non-public data (e.g., non-public consumer data) that is obtained only from a non-public data source.

In the embodiment of FIG. 4, the system 400 may enable or otherwise provide for an authorization to release anonymized consumer data 474. The authorization 474 may be explicit, such as an indication via a user interface presented by the consumer portal client 425 or a request by a consumer to transfer anonymized consumer data 446 to a vendor (e.g., to request an offer from the vendor). In other embodiments, the authorization 474 may be implicit, such as by providing information for a consumer profile 442, providing all requisite consumer data 444 to complete a consumer profile, and/or upon receipt of a validation notice 472 and/or validated consumer data 444a. Upon receipt of the authorization 474, the anonymized consumer data 446 associated with a corresponding consumer profile 442 may be released or otherwise made available for access by a vendor.

In the embodiment of FIG. 4, the system 400 transfers validated anonymized consumer data 446a to a vendor. More specifically, the vendor portal 428 may transfer validated anonymized consumer data 446a to the vendor portal client 429 on the vendor computing device 30. The vendor portal client 429 can present the validated anonymized consumer data 446a to a vendor, such as on a user interface.

The transfer of validated anonymized consumer data 446a provides assurance to a consumer that identity is safe and assurance to vendors that information received is accurate and corresponds to an actual consumer. Further the transfer of validated anonymized consumer data 446a enables transparency as to the characteristics of a consumer while preserving anonymity or the identity of the consumer.

The system 400 does not provide any identifying consumer data 445 to a vendor without the consent of the corresponding consumer, as described below with reference to FIGS. 6A and 6B. Nevertheless, access to the validated anonymized consumer data 446a can enable a vendor to determine one or more terms of a potential transaction with an anonymous consumer based on the anonymized consumer data 446. These actual terms can be used to generate and communicate vendor offer data for a potential transaction with the consumer, or otherwise efficiently market such transactions. The vendor can use the validated anonymized consumer data 446a to prepare optimized offers for an actual, although anonymized, consumer that can be delivered to the consumer via the system 400.

For example, a consumer may authorize release of validated anonymized consumer data 446a to request accurate and realistic data from vendor, such as terms of a home loan, and not initially provide any identifying consumer data 445. Accordingly, the consumer may request, shop, and/or otherwise review several home loan offers, without disclosing to any home loan vendors the consumer's physical address, telephone number, email address, and/or any other identifying consumer data 445 that may undermine a consumer's identity and cause concerns of being exposed to repercussions of releasing identifying information.

FIG. 5 illustrates a transfer of vendor data 550 via the system 400 of FIG. 4. In particular, FIG. 5 illustrates transfer of vendor data 550, and specifically vendor offer data 550a, based on validated anonymized consumer data 446a. A vendor may receive validated anonymized consumer data 446a from the vendor portal 428 of the system 400 via the vendor portal client 429, as described above with reference to FIG. 4. The vendor portal client 429 may enable a vendor to view the validated anonymized consumer data 446a and provide vendor data 550, including vendor offer data 550a, to the system 400.

The vendor portal 428 may receive the vendor data 550 from the vendor portal client 429 and store the received vendor data 550 in the electronic memory 404 of the system 400 in association with a vendor profile 548. The vendor portal 428 may also generate a vendor profile 548, using the vendor data 550, if a vendor profile 548 for the vendor does not exist.

Typically, validation of vendor data 550 is unnecessary. Vendors generally are attempting to market themselves and prefer to be anything but anonymous. A simple desire to preserve and build a positive reputation and/or to provide excellent customer service can provide adequate assurance that vendor offer data 550a is accurate, without validation. Nevertheless, some situations and circumstances may warrant validation of vendor data 550 and/or vendor offer data 550a. The vendor data 550 may be validated with the aid of the data institution(s) 50. A validation request 570 can be provided to the data institution(s) 50. The vendor data 550, or a portion thereof, may be transmitted to the data institutions 50 by the vendor portal 428 via the network 10. The data institution(s) 50 may inspect the vendor data 550, compare the vendor data 550 against known and reliable sources of information, and/or gather corroborating evidence to validate the vendor data 550. The data institution(s) 50 may validate the vendor data 550 by providing a validation notice 572 to the system 400.

As can be appreciated, vendor data 550 can be validated in various ways, as described above with reference to validation of consumer data 444 illustrated in FIG. 4. In some embodiments, validated vendor data is communicated to the system 400. In some embodiments the validation notice 572 may be communicated directly to the consumer portal client 425. Moreover, tracking and/or storage of vendor data 550 and validated vendor data may be implemented in a variety of ways, similar to those described above in relation to handling of consumer data 444 and validated consumer data 444a.

The vendor offer data 550a is transmitted from the system 400 to the consumer computing device 20. More specifically, the consumer portal 424 can transmit the vendor offer data 550a, via the network 10, to the consumer portal client 425 for presentation to a consumer. In the illustrated embodiment of FIG. 5, the system 400 facilitates transfer of vendor offer data 550a that is based on validated anonymized consumer data 446a. In other embodiments, the exchange of information may occur in any order, such that a vendor may provide vendor data 550, which is received by a consumer before the consumer provides consumer data 444 based on the vendor data 550. In still other embodiments, transfer of information of two parties to an exchange may occur contemporaneously and independent of any information provided by the other part to the exchange.

FIG. 6A is a relationship diagram of the system 400 of FIG. 4, illustrating an authorized release of identifying consumer data 445, according to one embodiment. A consumer can review the vendor offer data 550a received from the system 400 via the consumer portal client 425. The consumer may determine to accept the terms of the vendor offer. However, closing a deal or transaction may not be possible with an anonymous party, in this case the consumer. In order to complete preparation for such transaction, transfer of identifying consumer data 445 to the vendor may need to occur. In the embodiment of FIG. 6A, the identifying consumer data 445 may be provided to vendors only after a consumer consents to release identifying consumer data 445 to the vendor.

The consumer, through the consumer portal client 425, can provide an authorization to release identifying consumer data 674. The authorization 674 may be transmitted to the system 400 via the network 10. In other embodiments, the authorization 674 may be initially communicated over the network 10 from the consumer computing device 20 to the vendor computing device 30 to allow the vendor to determine when to exercise the authorization 674 (at which time the authorization 674 may be communicated to the system 400).

The authorization 674 may be for a specific vendor, such that other vendors cannot access the identifying consumer data 445. Upon receipt of the authorization 674 from the consumer, the system 400 can communicate the identifying consumer data 445 to the vendor computing device 30 of the specific vendor. The vendor may then be enabled to view the identifying consumer data 445 via the vendor portal client 429.

With access to the identifying consumer data 445 of a consumer, the vendor may have sufficient information to close a deal or financial transaction with that consumer. For example, in the case of a vendor offer for financial services, identifying consumer data 445 may provide information to supplement the financial information of the consumer (as delivered in the anonymized consumer data 446) and enable completion of documents for closing on the financial transaction. More specifically, the anonymized consumer data 446 may provide all the information needed for a vendor to establish the credit worthiness of a consumer for a loan, as one example. If the anonymized consumer data 446 is validated anonymized consumer data 446a, then the vendor may be prepared to lend to the anonymous consumer based on the provided financial credentials, upon obtaining identifying consumer data 445 that indicates to the vendor the identity of the consumer and other important information for entering into a binding agreement, such as where to send the statements, how to contact the consumer, and the like. In this manner, the system 400 can make available to a vendor all information desired in preparing to entering into a financial transaction with a consumer in an expedited and transparent manner.

FIG. 6B is a relationship diagram of the system 400 of FIG. 4, illustrating an authorized release of identifying consumer data, according to another embodiment. In this embodiment, a vendor uses a token 675 to demonstrate consumer authorization to release identifying consumer data. The vendor may receive the token 675 from the consumer external to the system 400, such as via an email, through the mail or other courier service, or by hand delivery. In other embodiments, the vendor may receive the token 675 through the system 400 (similar to the optional manner outlined above with reference to FIG. 6A). As described above, the token 675 may include one or more of a pin number, a password, a reference number, a magnetic card, a dongle, and/or a radio frequency identification (RFID) chip. The vendor may provide the token 675 to the system 400 such as through the vendor portal client 429, which can communicate the token 675 to the vendor portal 428 of the system 400 via the network 10.

The system 400 may allow a vendor to achieve an accepted vendor offer in much less time and with fewer man hours. Similarly, the system 400 may allow a consumer to accept and close on a vendor offer in much less time and with fewer man hours. The validated consumer data may include all documentation and/or information necessary to close on the accepted offer according to currently existing methods. As a result, the time required to find, accept, and close on a vendor offer (e.g., a home loan) may be greatly reduced. The vendor can transact more efficiently by expending resources to prepare terms for actual anonymized consumers based on validated anonymized consumer data 446a.

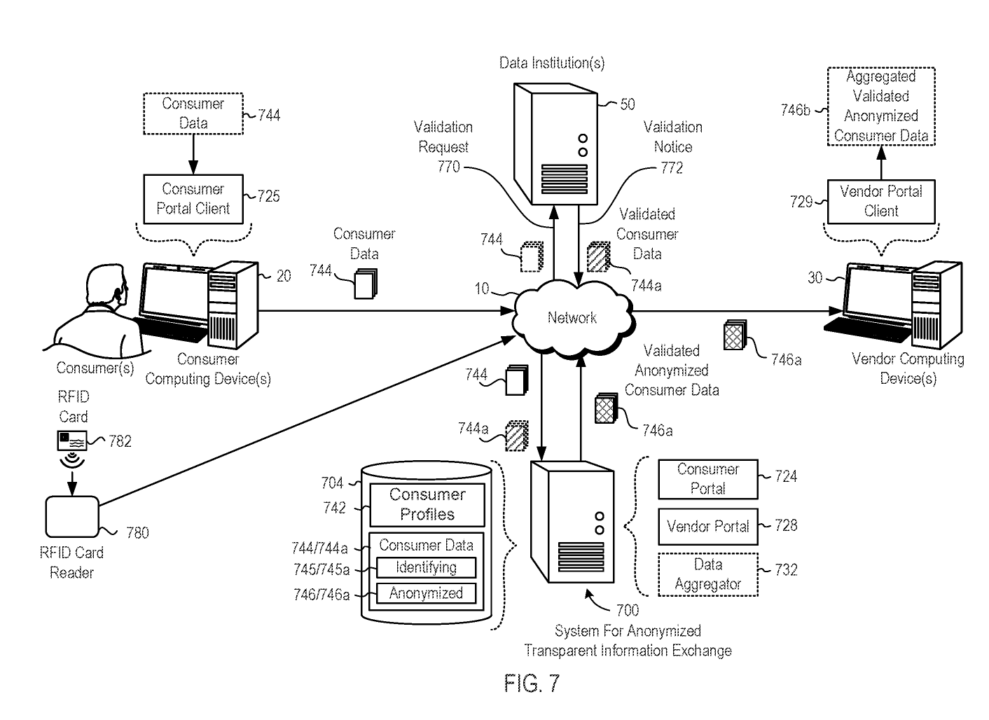

FIG. 7 is a relationship diagram of a system for facilitating anonymized and transparent exchange of information 700, according to another embodiment of the present disclosure, utilizing RFID technology and illustrating a process of receiving consumer data 744 and transferring validated anonymized consumer data 746a to a vendor computing device for aggregation. The RFID technology may detect, for example, an RFID card of a consumer at a location of the vendor. The system 700 can obtain and aggregate the validated anonymized consumer data 746a of the detected consumer and enable the vendor to view, access, or otherwise use aggregated anonymized consumer data 746b to assess the types of consumers on the vendor's premises at any given time. The vendor can use anonymized consumer data 746 (individual or aggregated) obtained through or based on an RFID reader to provide optimized offers for transactions (e.g., discount pricing, loan sale, special refinance terms, and the like) and may thereby gain a competitive advantage. The RFID reader may also allow the consumer to release identifying consumer data to the vendor, including releasing verification documents, and may increase the speed and/or efficiency of a future transaction.

The system 700 may include a consumer portal 724, a vendor portal 728, and an electronic memory 704 to store consumer profiles 742 and consumer data 744, which is sorted or otherwise separated into identifying consumer data 745 and anonymized consumer data 746. The system 700 may be in electrical communication with a network 10, which may provide electrical communication between multiple computing devices, including a consumer computing device 20, a vendor computing device 30, and/or one or more data institutions 50. The network 10 between the system 700 and the computing devices 20, 30, 50 may allow the system 700 to send and receive various kinds of data to and from each of the computing devices 20, 30, 50. A consumer may utilize a consumer portal client 725 on the consumer computing device 20 to interface with the consumer portal 724 of the system 700 to upload consumer data 744 to the system 700. The system 700 facilitates anonymizing data (e.g., consumer data), validating data, and/or exchanging data with another party.

FIG. 7, specifically, illustrates receipt of consumer data 744 from a consumer at the system 700 and transfer of validated anonymized consumer data 746a to a vendor, which aggregates validated anonymized consumer data of a plurality of consumers. A consumer may upload consumer data 744 via the consumer portal client 725 of the consumer computing device 20, which transfers the consumer data 744 over the network 10 to the consumer portal 724 of the system 700.

The consumer portal 724 may validate all or a portion of the consumer data 744 to better ensure accuracy of the consumer data 744 and thereby provide vendors with greater assurance of the accuracy of consumer data 744. The consumer portal 724 may transmit, over the network 10, all or a portion of the consumer data 744 and/or a validation request 770 to a data institution 50.

The data institutions 50 receive the validation request 770 and/or the consumer data 744 and validate accuracy of the consumer data 744. The data institutions 50 can send validated consumer data 744a and/or a validation notice 772 to the system 700.

The system 700 may receive validated consumer data 744a from the data institutions 50 and store the validated consumer data 744a in the electronic memory 704. The system 700, and specifically the consumer portal 724, may sort the validated consumer data 744a into validated identifying consumer data 745a and validated anonymized consumer data 746a. The identifying consumer data 745 may include any data enabling determination of an identity of the consumer (e.g., name of the consumer, a phone number, an address, a Social Security number, an identification number). The anonymized consumer data 746 may include data incapable of uniquely identifying the consumer (e.g., tax return information with identifying information redacted, a deposit account balance, a credit score, employment information, monthly income, monthly debts, and city, county, state, country, and/or zip code of residence).

The system 700 enables a vendor to aggregate consumer data 744, and specifically validated anonymized data 746, for a plurality of consumers. The aggregated validated anonymized data 746b may be data mined or otherwise analyzed to learn about characteristics of a target group or other desired group of consumers.

In the illustrated embodiment of FIG. 7, RFID technology, including an RFID card reader 780 to detect an RFID tag such as an RFID card 782, is used to detect a consumer, such as at a vendor's physical place of business. Upon detection of an RFID card 782 associated with a consumer by the RFID card reader 780, a corresponding consumer profile 742 may be queried and corresponding validated anonymized consumer data 746a may be retrieved from the electronic memory 704 of the system 700.

The system 700 transfers validated anonymized consumer data 746a to the vendor associated with the RFID card reader 780 for aggregation by the vendor. More specifically, the vendor portal 728 may transfer validated anonymized consumer data 746a to a vendor portal client 729 on the vendor computing device 30. The transfer of validated anonymized consumer data 746a provides assurance to a consumer that identity is anonymous and assurance to vendors that information received is accurate and corresponds to an actual consumer. Further the transfer of validated anonymized consumer data 746 enables transparency as to the characteristics of a consumer while preserving anonymity or the identity of the consumer.

The validated anonymized consumer data 746a can be aggregated by the vendor portal client 729 on the vendor computing device 30. A vendor may desire to aggregate information regarding a target group or other desired group of consumers. The target group may be defined by preferences, criteria, rules, or the like provided by a vendor. When a consumer is determined to be within the target group, the corresponding validated anonymized consumer data 746a is retrieved (e.g., from the electronic memory 704) and aggregated into or with the vendor's store of aggregated validated anonymized consumer data 746b.

The system 700 may optionally or alternatively include a data aggregator 732 to aggregate validated anonymized consumer data 746a for a plurality of consumer profiles for a plurality of detected consumers. The data aggregator 7632 aggregates validated anonymized consumer data 746 from a plurality of consumer profiles, which correspond to a plurality of detected consumers. The system 700 may aggregate all consumer activity and corresponding anonymized consumer data 746a. The data aggregator 732 then delivers the aggregated validated anonymized consumer data 746b to specific vendors, according to each vendor's criteria or rules, using the vendor portal 728 to transmit over the network 10 to the vendor portal client 729 on the vendor computing device 30. In other words, the system 700 may aggregate all consumer data 744 and deliver specific slices to vendors according to vendor preferences, criteria, and rules.

In some embodiments, the data aggregator 732 may include the RFID card reader 780 to detect the presence of consumers at a location. The RFID card reader 780 may couple to the system 700 over the network 10 (e.g., via the Internet), as shown. In other embodiments, the RFID card reader 780 may couple to the system 700 through an I/O interface. The vendor can use the anonymized consumer data 746/746a/746b (individual or aggregated) obtained through or based on the RFID card reader 780 to determine terms for potential offers for transactions (e.g., discount pricing, loan sale, special refinance terms, and the like). The vendor can also use the anonymized consumer data 746 to aggregate demographic and other data about its consumers. For example, the vendor may desire to understand the types of customers that visit the storefront between the hours of 5:00 pm and 7:00 pm during the week, to understand if marketing resources are reaching a desired consumer. Or the vendor may know that the busiest time at the store is on weekends and may wish to prepare targeted advertising or offers for consumers who enter the store (or who are likely to enter, as determined based on previously analyzed aggregated validated anonymized consumer data 746b). When a consumer is detected by the RFID card reader 780, an offer can be automatically generated to target that consumer, despite not knowing the identity of the consumer. In this manner, the vendor can work more efficiently to generate offerings to consumers, as offers either through the system 700 or simply through traditional marketing techniques, that may be of particular interest to those consumers. As described above, the anonymized consumer data 746 includes only information that the vendor cannot use to identify a particular consumer, but nonetheless can utilize to learn about consumers. The validated anonymized consumer data 746a can enable vendors to be dramatically more efficient in communicating to consumers.

In some embodiments, the data aggregator 732 may also include other consumer detection technology, such as a page view detector or Internet reader to detect consumers who view a webpage of the vendor. A page view detector and/or an Internet reader may collect anonymized consumer data 746 for the data aggregator 732 to organize and/or group according to one or more consumer tracking metrics. The page view detector and/or an Internet reader may function similar to the RFID card reader 780 to identify public consumers visiting the virtual premises (e.g., website and, mobile application) of the vendor. The data aggregator 732 may bundle/organize anonymized consumer data 746 that is collected by vendors or the Internet reader, or otherwise provided to the system 700, according to one or more consumer tracking metrics. Examples of consumer tracking metrics may include consumer income, county of residence, employment status, or any other relevant consumer characteristic.

The vendor portal client 729 can present the aggregated validated anonymized consumer data 746b to a vendor, such as on a user interface. The vendor portal client 729 may also enable the aggregated validated anonymized consumer data 746b to be organized by one or more consumer tracking metrics. For example, aggregated validated anonymized consumer data 746b may be organized to provide information on consumers in a particular income bracket. Aggregated validated anonymized consumer data 746b may also be organized by the system 700 to provide information on consumers of a particular employment status, home zip code, and/or any other relevant consumer tracking metric.

The aggregated validated anonymized consumer data 746b can be data mined or otherwise queried to detect common characteristics of detected consumers, to identify trends, patterns and the like, such as to characterize the types of consumers detected in a given period of time.

As can be appreciated, the embodiment of FIG. 7 can be useful to a vendor desiring to learn or otherwise determine attributes or characteristics, such as financial standing, of consumers that visit the premises of the vendor or other location of interest to the vendor.

The system 700 does not provide any consumer identifying data 745 to a vendor without the consent of the corresponding consumer (e.g., as described above with reference to FIGS. 6A and 6B). Nevertheless, the vendor can use the aggregated validated anonymized consumer data 746b to prepare optimized offers for a target group of consumers. The vendor can aggregate anonymous data, for example to learn more about consumers and assess local and Internet visitors and marketing results. Further, the aggregated anonymous data and assessment may also be used by the vendors to optimize offers to gain a competitive advantage. The vendor can prepare optimized offers for actual, although anonymous, consumers. In other words, the vendor can transact more efficiently by expending resources to prepare terms for actual anonymized consumers based on aggregated validated anonymized consumer data 746b.

The system 700 may be utilized by a consumer to facilitate anonymous and accurate review of vender offers and offer data, in a variety of settings, both physical and virtual. For example, when meeting with vendor in person a consumer's RFID card 782 may provide the consumer's validated anonymized consumer data 746a to the vendor, without providing to the vendor any identifying consumer data 745. The vendor may make vendor offers to the consumer, based on the validated anonymized consumer data 746a. As additional examples, a consumer may use the system 700 while discussing offer data with a vendor during a telephone conversation, an email correspondence, or any other setting in which the consumer may review vendor offers and/or vendor offer data. The consumer may also use the system 700 to interface with a vendor in a virtual setting, such as shopping for goods or services (e.g., requesting terms) on the vendor's website or mobile application. A secure, anonymous, and transparent exchange of information is enabled by the system 700, which otherwise could not be accomplished efficiently using other presently available systems and methods.

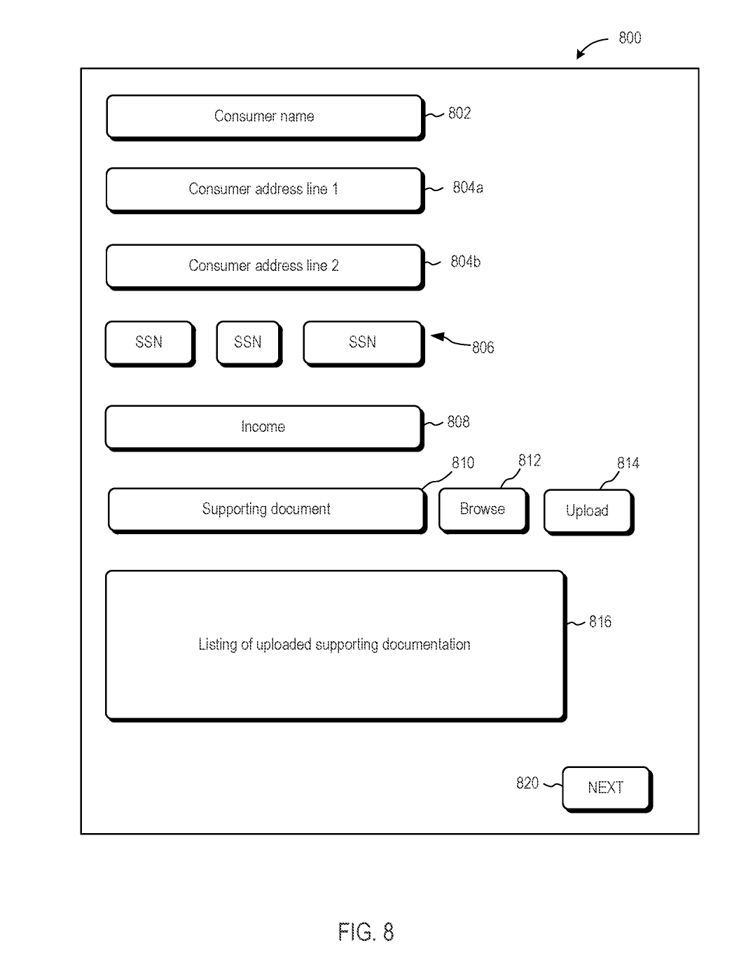

FIG. 8 is a user interface 800 of a consumer portal of a system for facilitating anonymized and transparent exchange of information, according to one embodiment of the present disclosure. The user interface 800 includes a plurality of fields and components that receive input of consumer data. The user interface 800 includes a consumer name input field 802, a consumer address input field 804a, 804b (collectively 804), a Social Security number input field 806, an income input field 808, a supporting document upload field 810, a browse input component 812, an upload input component 814, a listing of uploaded supporting documentation 816, and a next navigation input component 820. Using these fields and components, a consumer may provide consumer data. The document upload field 810 may enable uploading of documents such as pay stubs, tax returns, loan balance statements, and the like. As can be appreciated, other user interfaces may be configured to receive other pieces of consumer data. Moreover, additional consumer data may be received from data institutions as validated consumer data.

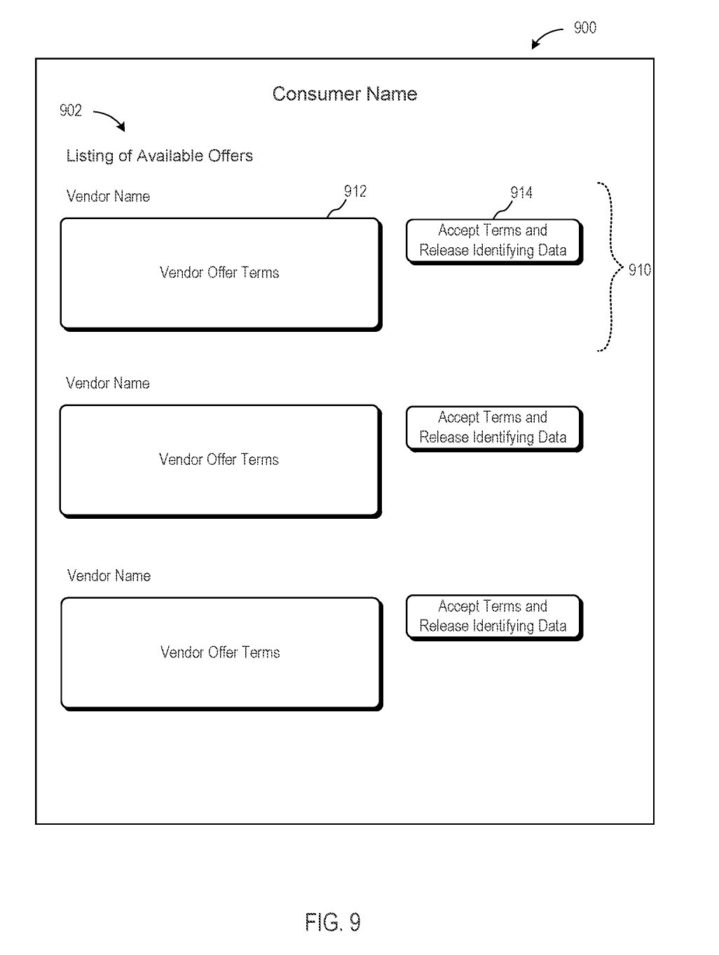

FIG. 9 is another user interface 900 of a consumer portal of a system for facilitating anonymized and transparent exchange of information, according to one embodiment of the present disclosure. The user interface 900 presents a listing of available offers 902, which presents a visual portrayal of one or more vendor offers 910. The visual portrayal of a vendor offer 910 includes vendor offer terms 912. In the case of an offer for a financial service, the vendor offer terms 912 may include an indication of an interest rate (e.g., an actual interest rate or a percentage over prime), a period for repayment, an amount, and the like. In the case of an offer of employment, the vendor offer terms 912 may include position, pay rate, benefits, and the like.

The user interface 900 also provides an input component 914 (e.g., a button) to accept the vendor offer terms and release identifying data to the vendor. Actuation of this input component 914 may cause a message to be sent to the vendor that the consumer has accepted the terms of the offer. In some embodiments, acceptance of the terms of the offer may communicate a message to the vendor that the consumer accepts a binding agreement or contract with the vendor. In still other embodiments, acceptance of the terms may initiate an automatic processing of a transaction according to the terms.

Also, actuation of this input component 914 may cause the consumer portal to communicate an authorization to the corresponding vendor to access the identifying consumer data of the consumer profile of the consumer. For example, a token may be transmitted to the vendor. As can be appreciated, in some embodiments, separate input components, such that a first input component may be provided for accepting the terms and a second input component may be provided for releasing identifying data to the vendor.

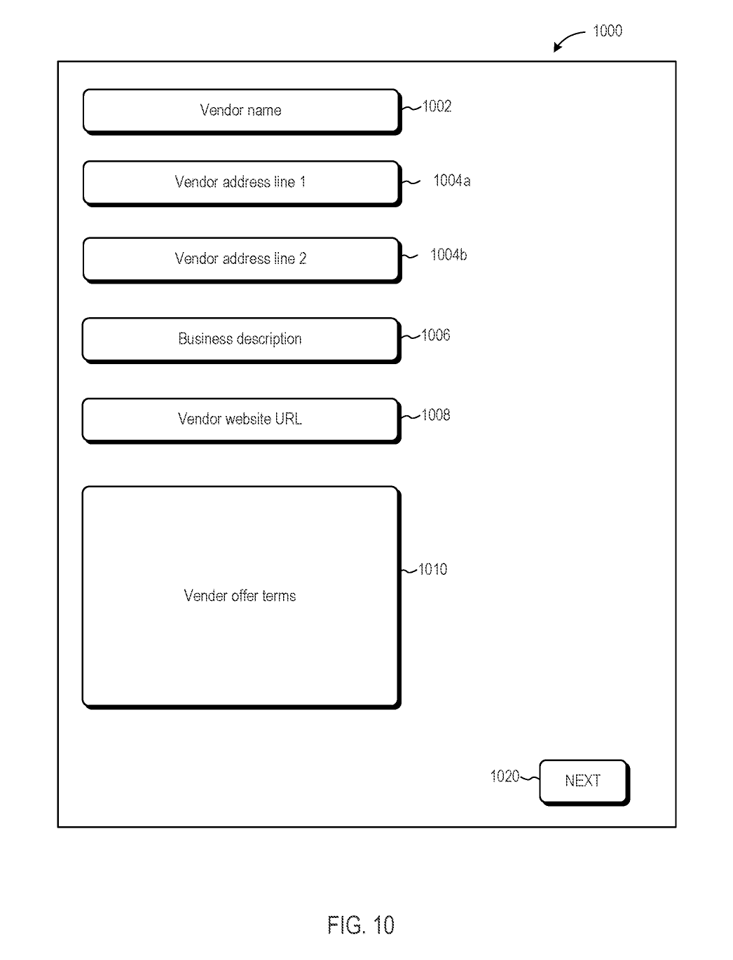

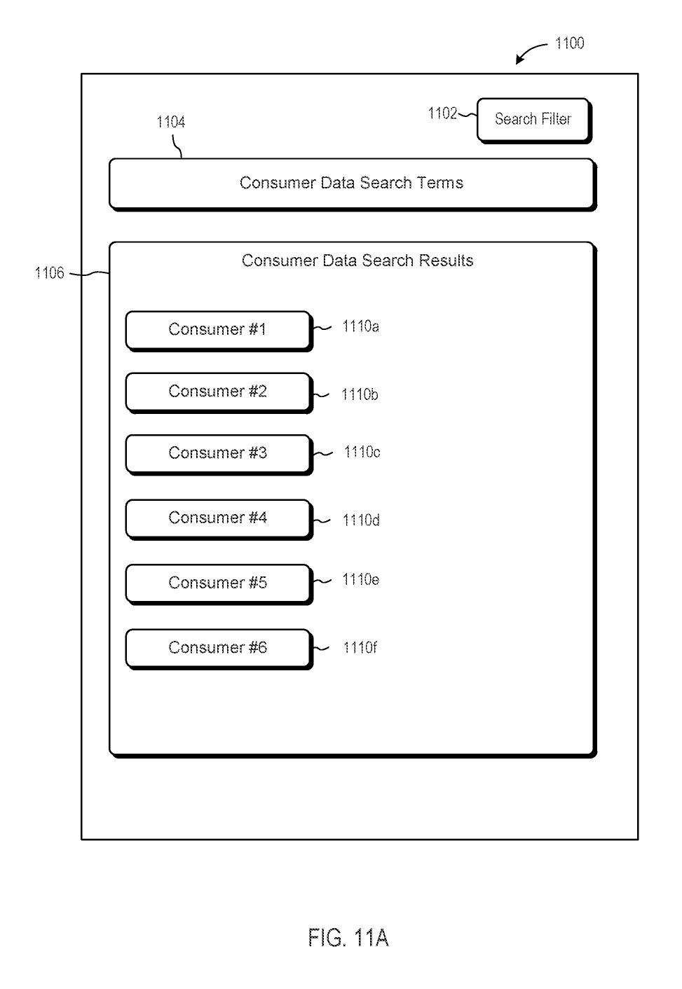

FIG. 10 is a user interface 1000 of a vendor portal of a system for facilitating anonymized and transparent exchange of information according to one embodiment of the present disclosure. The user interface 1000 includes a plurality of fields and components that receive input of vendor data. The user interface 1000 includes a vendor name input field 1002, a vendor address input field 1004a, 1004b (collectively 1004), a business description input field 1006, a vendor website URL input field 1008, a vendor offer terms input field 1010, and a next navigation input component 1020. The vendor offer terms provided by the vendor can depend on the type of offer. In the case of a transaction for a good or service, the vendor offer terms may include a term, such as an interest rate or a fee, that provides a vendor margin that is above the vendor's cost to render the good or service, which may include the cost to prepare the offer and/or otherwise communicate the offer or offer terms to the consumer.

The vendor's cost may depend on characteristics of the consumer. To account for varying characteristics of consumers, the vendor offer terms may be provided in the form of rules specifying criteria for selecting consumers and terms for consumers that meet those criteria. For example, in the case of providing a financial service to a consumer, such as a mortgage, the vendor's cost may be based on the vendor's access to capital, and an interest rate at which the vendor can access the capital for a consumer with a given credit score, income level, debt ratio, and the like. As such, the vendor offer terms for a mortgage may be provided in the form of one or more rules that begin with a cost of access to capital to lend the money for the mortgage and that indicate how the terms will adjust from that cost of money, based on the criteria of the consumer. The rules may provide a vendor offer terms for a type of loan, fees, and/or for an interest rate for which a consumer meeting the criteria is eligible. The vendor's ability to have confidence that the consumer data received is accurate and validated enables the vendor to more efficiently respond to a consumer request for an offer with actual terms based on the consumer's actual characteristics. In other words, the accurate transmission of data enabled and ensured by the presently disclosed embodiments dramatically improves efficiency of exchanging information, and can thereby dramatically expedite transactions.

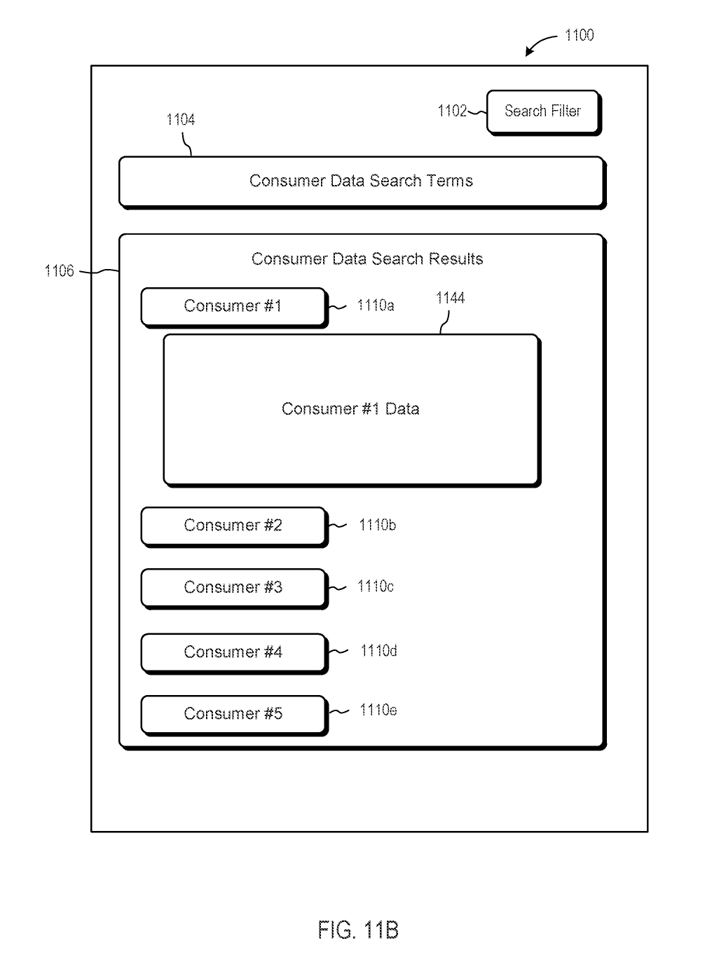

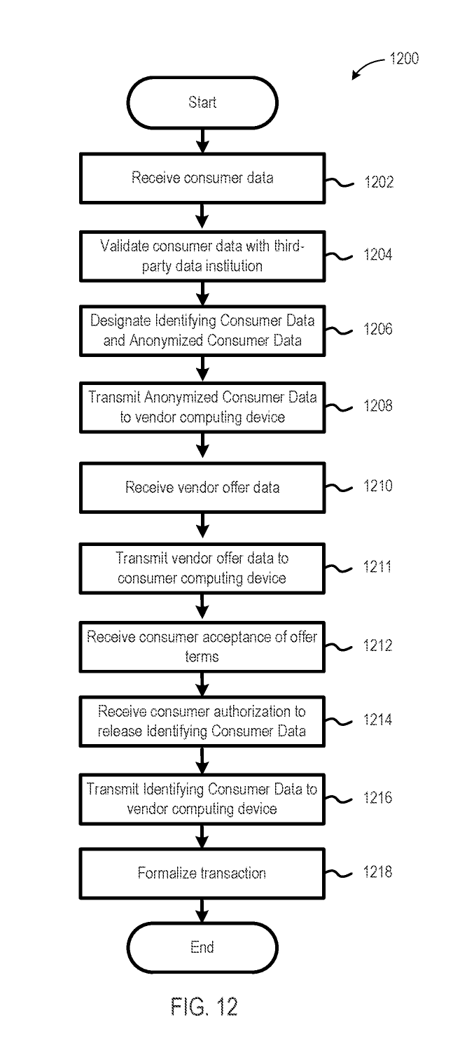

FIG. 11A is a user interface 1100 of a vendor portal of a system for facilitating anonymized and transparent exchange of information, according to one embodiment of the present disclosure. The user interface 1100 provides a search filter input component 1102, which may direct a search of consumer data based on search terms provided in a consumer data search terms input field 1104. The results of the search of consumer data may be presented in the form of a listing of consumer data search results 1106. The listing 1106 may provide graphical representation of consumer profiles 1110a-f that include consumer data that match the consumer data search terms. FIG. 11B is the user interface 1100 of FIG. 11A displaying consumer data 1144 of a selected consumer profile 1110.

FIG. 12 is a flow diagram of a method 1200 of anonymized transparent exchange of information, according to one embodiment. The method 1200 may be a computer-implemented method that may be executed on or by a system for anonymized transparent exchange of information. Consumer data may be received 1202 from a consumer, such as from a consumer computing device, and/or from a data institution via a network. The consumer data can be validated 1204 with a third-party data institution, and particularly consumer data received directly from a consumer. A portion of the consumer data is designated 1206 as identifying consumer data, and another portion of the consumer data is designated 1206 anonymized consumer data. The designation may be determined by processing of a computing device, based on criteria, rules, and the like. The consumer data may be analyzed and/or processed to extract identifying consumer data from consumer data received, such that only anonymized consumer data remains. The extraction may include parsing strings of data to identify identifying information such as name, address, phone number, identification numbers (e.g., Social Security number, driver license number, passport number, and the like) to remove or otherwise redact such information from the anonymized consumer information.

Anonymized consumer data can be transmitted 1208 over a network to a vendor computing device. The anonymized consumer data can be transmitted 1208 upon a request from a vendor, upon an instruction from a consumer, and/or upon a detection of a consumer. The anonymized consumer data is then received by the vendor to allow the vendor to determine information to communicate back to the consumer. For example, the anonymized consumer data can be used by a vendor to generate vendor offer terms, such as for an offer to provide financial services. Because the consumer data has been validated 1204, a vendor can interface with the anonymous consumer with confidence that the consumer data represents or otherwise provide real and accurate information pertaining to a real consumer (individual, entity, or other organization or group). The accuracy of the anonymized consumer data enables the vendor to transact or otherwise interface with the consumer in a more efficient manner.

Vendor offer data can be received 1210 from a vendor, such as from a vendor computing device via a network. The vendor offer data may be received 1210 before the consumer data is received 1202 or after validated anonymized consumer data is transmitted 1208 to the vendor. The vendor offer data may be received 1210 as specific terms or as rules for determining terms of a vendor offer, such as an offer of financial services. The rules may specify criteria for selecting consumers and for setting terms of an offer to consumers that meet the criteria. In the case where vendor offer data is received 1210 or otherwise embodied as rules, vendor offer terms may be automatically determined or otherwise generated.

The vendor offer data can be transmitted 1211 to one or more consumers, such as to a consumer computing device over a network. The consumer then has an opportunity to review the vendor offer data, including any terms of offer, to assess whether there is an interest in obtaining the goods or services. In the case of a consumer seeking financial services, the consumer can consider the vendor offer data with confidence that the terms are actual terms that would apply to an actual transaction, because the consumer has provided accurate information to the vendor by the validated anonymized consumer data. The consumer can also have confidence that, because the consumer data is anonymized, the identity of the consumer remains safe and unknown to the vendor. If the consumer determines that the terms are acceptable, the consumer can communicate acceptance of the terms. A consumer acceptance of the offer terms can be received 1212, such as from a consumer computing device via a network. Also, in the same communication of the consumer acceptance or in a separate communication, authorization to release identifying consumer information is provided. The authorization may be communicated directly to the vendor through the system or via other method or means. For example, the consumer may give the vendor a token that can be used to demonstrate authorization to receive, obtain, or otherwise access the identifying information of the consumer.

The consumer authorization to release the identifying consumer information is received 1214, such as from the consumer or from the vendor. The vendor may provide a token to demonstrate authorization to access the identifying consumer information corresponding to the consumer's profile. Once the authorization is received 1214, the identifying consumer data can be transmitted 1216 to the vendor, such as to a vendor computing device via a network.

In certain embodiments, the exchange of accurate consumer information and vendor information can result in complete preparation for a transaction, such as a transaction for financial services. In such embodiments, the transaction may be automatically formalized 1218. For example, documents may be generated and execution of such documents may even be possible, such as electronically.

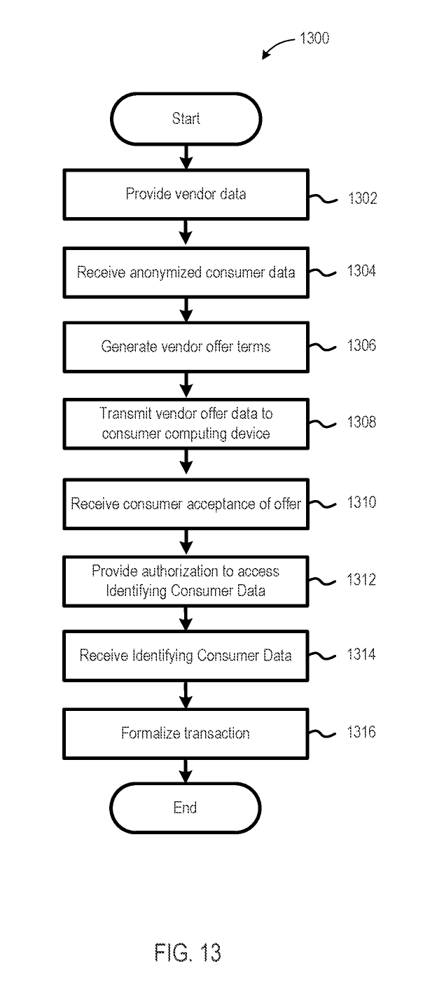

FIG. 13 is a flow diagram of a method 1300 of anonymized transparent exchange of information, according to another embodiment. The method 1300 may also be a method 1300 of collecting consumer data. Vendor data is provided 1302, which may include profile data for generating a vendor profile and vendor offer data, such as specific terms or rules for generating terms of an offer. The vendor data may also include criteria for detecting or otherwise selecting consumers for aggregating consumer data. The vendor data may be provide 1302 via a computing device, over a network.

Consumer anonymized data is received 1304, such as at the computing device over the network. Vendor offer terms are generated 1306 based on the consumer anonymized data and the vendor offer data is transmitted 1308 to a consumer computing device. As described, the consumer may determine to accept the offer and a consumer acceptance of the offer 1310 can be received. The consumer may separately provide to the vendor a token or other authorization to access identifying consumer data of the consumer. The vendor may then provide 1312 the token or other authorization to access the identifying consumer data. The identifying consumer data is then received 1314. With all of the consumer data, both the anonymized consumer data and the anonymized consumer data, a transaction may be formalized 1316.

As can be appreciated, other methods and processes are available and included in the descriptions above describing operation of the system embodiments and are within the scope of the present disclosure.

### EXAMPLE EMBODIMENTS

Some examples of embodiments of systems and methods of anonymized transparent exchange of information are provided below.

### Example 1

A system for facilitating anonymized and transparent exchange of information, the system comprising: one or more processors, electronic memory, a network interface, a consumer portal, and a vendor portal. The electronic memory is accessible by the one or more processors. The electronic memory can store consumer profiles that include consumer data and a consumer token, wherein a portion of the consumer data is designated anonymized consumer data and another portion of the consumer data is designated identifying consumer data. The network interface can enable communication with one or more computing devices over an electronic communication network. The consumer portal can, by the one or more processors: enable a consumer to: upload to the system (for storage in the electronic memory) consumer data pertaining to a consumer profile for the consumer, authorize release of identifying consumer data of the consumer profile to a selected vendor, wherein authorization involves the consumer token of the consumer profile, and review vendor offer data from one or more vendors, including the selected vendor. The consumer portal can further, by the one or more processors; one or more of download consumer data for the consumer profile from one or more data institutions and validate accuracy of consumer data for the consumer profile with one or more data institutions by communication via the network interface over the network with a computing system of each of the one or more data institutions; and designate a portion of consumer data for the consumer profile as identifying consumer data and another portion of the consumer data for the consumer profile as anonymized consumer data. The vendor portal can, by the one or more processors; enable a vendor to: view anonymized consumer data for the consumer profile; provide vendor offer data to the consumer, based on the anonymized consumer data for the consumer profile; and with authorization from the consumer, access identifying consumer data for the consumer profile.

### Example 2

The system of Example 1, wherein the consumer portal further enables a consumer to request a consumer profile be generated for the consumer.

### Example 3

The system of Example 1, wherein the consumer portal further enables a consumer to consent to release of anonymized consumer data of the consumer profile to a selected vendor.

### Example 4

The system of Example 1, wherein the consumer portal further enables a consumer to accept a vendor offer presented by the vendor offer data.

### Example 5

The system of Example 1, wherein the consumer portal further enables a consumer to request validation of uploaded consumer data.

### Example 6

The system of Example 1, wherein the vendor offer data presents an offer of financial services.

### Example 7

The system of Example 6, wherein the offer of financial services includes one or more of a mortgage, an auto loan, a line of credit, a credit card, and an insurance policy.

### Example 8

The system of Example 1, wherein to validate accuracy of consumer data for the consumer profile with one or more data institutions comprises verifying the accuracy via the one or more data institutions.

### Example 9

The system of Example 1, wherein the vendor portal further enables a vendor to use a consumer token received from the consumer to demonstrate consumer authorization to access identifying consumer data of the consumer profile.

### Example 10

The system of Example 1, further comprising a data aggregator to aggregate anonymized consumer data for a plurality of consumer profiles, including the consumer profile, for a plurality of detected consumers, wherein the vendor portal further enables a vendor to view aggregated anonymized consumer data for the plurality of consumer profiles.

### Example 11

The system of Example 10, further comprising a radio frequency identification (RFID) reader to detect a presence of each of the plurality of detected consumers at a location, wherein the data aggregator aggregates anonymized consumer data from the plurality of consumer profiles, which correspond to the plurality of detected consumers.

### Example 12

The system of Example 10, further comprising a radio frequency identification (RFID) reader to detect a presence of each of the plurality of detected consumers at a location, wherein, upon detection of a consumer, the system automatically communicates corresponding anonymized consumer data to a vendor associated with the RFID reader.

### Example 13

The system of Example 10, further comprising a consumer detector (or Internet reader) to detect each of the plurality of detected consumers who view a webpage of the vendor, wherein the data aggregator aggregates anonymized consumer data from the plurality of consumer profiles, which correspond to the plurality of detected consumers.

### Example 14

The system of Example 10, further comprising a consumer detector (e.g., a page view detector or Internet reader) to detect each of the plurality of detected consumers who views a webpage of the vendor, wherein, upon detection of a consumer, the system automatically communicates corresponding anonymized consumer data to a vendor associated with the consumer detector.

### Example 15

The system of Example 10, wherein the vendor portal is further configured to enable the vendor to provide vendor offer data to one or more of the plurality of detected consumers, based on aggregated anonymized consumer data from the plurality of consumer profiles, which correspond to the plurality of detected consumers.

### Example 16

The system of Example 1, wherein the anonymized consumer data includes only consumer data not capable of uniquely identifying the consumer.

### Example 17

The system of Example 1, wherein the anonymized consumer data comprises non-identifying consumer financial information, including one or more of tax return information with identifying information redacted, a deposit account balance, a credit score, employment information, monthly income, monthly debts, county of residence, and zip code of residence.

### Example 18

The system of Example 1, wherein the anonymized consumer data comprises both public data that is publicly available and non-public data that is obtained only from a non-public data source.

### Example 19

The system of Example 1, wherein the identifying consumer data comprises consumer data enabling determination of an identity of the consumer.

### Example 20

The system of Example 1, wherein the identifying consumer data comprises one or more of a name of the consumer, a phone number, an address, a Social Security number, an identification number, an employee identification number, a deposit account number, a credit card number, an email address, and a social media account.

### Example 21

The system of Example 1, wherein the consumer token comprises one or more of a pin number, a password, and a reference number.

### Example 22

The system of Example 21, wherein the consumer token is transportable on one of a magnetic card, a dongle, and a radio frequency identification (RFID) chip.

### Example 23

A computer-implemented method for anonymized and transparent exchange of information, the method comprising: receiving, at a server computing system, consumer data pertaining to a consumer profile stored in an electronic memory accessible by the server computing system, the consumer profile including a consumer token; designating on the server computing system a portion of the consumer data as anonymized consumer data and another portion of the consumer data as identifying consumer data; storing the consumer data in association with the consumer profile in the electronic memory accessible by the server computing system; receiving, at the server computing system over an electronic communication network, from one or more data institutions, a validation of accuracy of at least a portion of the consumer data; transmitting, over the electronic communication network, the anonymized consumer data for the consumer profile to a vendor computing device of a vendor; receiving, at the server computing system over the electronic communication network, vendor offer data from the vendor computing device; presenting the vendor offer data to a consumer associated with the consumer profile; receiving at the server computing system an authorization to release identifying consumer data for the consumer profile to the vendor, the authorization involving the consumer token of the consumer profile; and transmitting, over the electronic communication network, the identifying consumer data for the consumer profile to the vendor computing device.

### Example 24

The method of Example 23, further comprising receiving consumer consent to release of anonymized consumer data of the consumer profile to the vendor.

### Example 25

The method of Example 23, wherein the validation determines a portion of the consumer data that is validated consumer data, and wherein transmitting the anonymized consumer data for the consumer profile to a vendor computing device includes transmitting at least a portion of the validated consumer data.

### Example 26

The method of Example 23, further comprising requesting, by the server computing system, over the electronic communication network from the computing system of each of the one or more data institutions, validation of accuracy of at least a portion of the consumer data.

### Example 27

The method of Example 26, wherein requesting validation of accuracy of the portion of the consumer data comprises transmitting the portion of the consumer data to the one or more data institutions.

### Example 25

The method of Example 23, wherein receiving validation of accuracy of consumer data includes one or more of: receiving at the server computing system consumer data for the consumer profile from the one or more data institutions by communication over a network with a computing system of each of the one or more data institutions via a network interface; and confirming accuracy of consumer data for the consumer profile with one or more data institutions by communication over the network with the computing system of each of the one or more data institutions via the network interface.

### Example 26

The method of Example 23, wherein receiving the validation of accuracy of at least the portion of the consumer data comprises verifying the accuracy via the one or more data institutions.

### Example 27

The method of Example 23, further comprising: generating a consumer profile for the consumer, including generating the consumer token to uniquely identify the consumer and enable release and/or access to identifying consumer data associated with the consumer profile; and storing the consumer profile in the electronic memory accessible by the server computing system in association with the consumer profile.

### Example 28

The method of Example 23, further comprising receiving at the server computing system consent of the consumer to release anonymized consumer data of the consumer profile to the vendor.

### Example 29

The method of Example 23, further comprising: receiving from the consumer a request to validate a portion of consumer data for the consumer profile; and transmitting a validation request by communication over the network, to a computing system of a data institution of the one or more data institutions, the validation request to request a confirmation of accuracy of the portion of consumer data for the consumer profile.

### Example 30

A system for aggregating data of a plurality of consumers, the system comprising: one or more processors; electronic memory accessible by the one or more processors, the electronic memory to store a plurality of consumer profiles that each include consumer data and a consumer token, wherein for each of the plurality of consumer profiles a portion of the consumer data is designated anonymized consumer data and another portion of the consumer data is designated identifying consumer data; a network interface to enable communication with one or more computing devices over an electronic communication network; a data validation engine to, by the one or more processors, validate accuracy of consumer data for the consumer profile with one or more data institutions by communication over the network with a computing system of each of the one or more data institutions via the network interface; and a consumer detector to detect consumers and, by the one or more processors, retrieve from the electronic memory the anonymized consumer data for a consumer profile for each detected consumer; and a consumer data aggregator to, by the one or more processors, aggregate the anonymized consumer data for the consumer profile for each detected consumer.

### Example 31

The system of Example 30, further comprising a consumer portal to, by the one or more processors: enable a consumer to upload to the system, for storage in the electronic memory, consumer data pertaining to a consumer profile for the consumer; and designate a portion of consumer data for the consumer profile as identifying consumer data and another portion of the consumer data for the consumer profile as anonymized consumer data.

### Example 32

The system of Example 30, further comprising: a vendor portal to, by the one or more processors: enable a vendor to one or more of: view aggregated anonymized consumer data; and based on the aggregated anonymized consumer data, present vendor offer data to a consumer computing device over the network.

### Example 33

The system of Example 30, wherein the consumer detector detects consumers at a vendor location.

### Example 34

The system of Example 33, wherein the vendor location is a physical location.

### Example 35

The system of Example 34, wherein the physical location is a retail location.

### Example 36

The system of Example 34, wherein the consumer detector comprises radio frequency identification (RFID) technology to detect RFID tags associated with consumers at the physical location.

### Example 37

The system of Example 30, wherein the vendor location is a virtual location

### Example 38

The system of Example 37, wherein the virtual location is a website.

### Example 39

The system of Example 30, wherein the consumer detector detects consumers at a target location.

### Example 40

The system of Example 30, wherein the consumer data aggregator aggregates the anonymized consumer data according to criteria specifying consumer characteristics in the consumer anonymized data, wherein the criteria to be received from the vendor.

### Example 41

The system of Example 30, wherein the consumer token comprises a tangible object that includes one or more of a pin number, a password, and a reference number.

### Example 42

A computer-implemented method for aggregating consumer data, the method comprising: receiving, at a server computing system, consumer data pertaining to a plurality of consumer profiles stored in an electronic memory accessible by the server computing system, each consumer profile of the plurality of consumer profiles including a consumer token that is unique; designating on the server computing system, for each consumer profile of the plurality of consumer profiles, a portion of the consumer data as anonymized consumer data and another portion of the consumer data as identifying consumer data; storing the consumer data in the electronic memory accessible by the server computing system, wherein the consumer data is stored in association with the plurality of consumer profiles; receiving, at the server computing system over an electronic communication network, from one or more data institutions, a notice of validation of accuracy of at least a portion of the consumer data; detecting a presence of a plurality of consumers; retrieving, by the server computing system from the electronic memory, anonymized consumer data for a consumer profile for each detected consumer of the plurality of consumers; and aggregating the anonymized consumer data for the plurality of consumers.

### Example 43

The method of Example 42, further comprising: providing one or more vendors with access, over the electronic communication network, to aggregated anonymized consumer data for the plurality of consumers.

### Example 44

The method of Example 43, further comprising: enabling one or more vendors to present, over the electronic communication network, vendor offer data based on the aggregated anonymized consumer data for the plurality of consumers.

### Example 45

The method of Example 42, further comprising: transmitting, over the electronic communication network, aggregated anonymized consumer data for a plurality of consumers to a vendor computing device of a vendor.

### Example 46

The method of Example 42, wherein detecting the plurality of consumers comprises detecting a consumer at a vendor location.

### Example 47

The method of Example 46, wherein the vendor location is a physical location.

### Example 48

the method of example 47, wherein the physical location is a retail location.

### Example 49

The method of Example 42, wherein detecting the plurality of consumers comprises utilizing radio frequency identification (RFID) technology to detect RFID tags associated with consumers at the physical location.

### Example 50

The method of Example 42, wherein the vendor location is a virtual location

### Example 51

The method of Example 50, wherein the virtual location is a website.

### Example 52

The method of Example 42, further comprising: requesting the one or more data institutions validate the accuracy of at least a portion of the consumer data.

### Example 53

The method of claim 20, wherein requesting the one or more data institutions validate includes transmitting the portion of the consumer data to the one or more data institutions over the electronic communication network.

### Example 54

A computer-readable storage medium having stored thereon instructions that, when executed by one or more processors, cause a computing device to perform operations to: receive, at the computing device, consumer data pertaining to a plurality of consumer profiles stored in an electronic memory accessible by the computing device, each consumer profile of the plurality of consumer profiles including a consumer token that is unique; designate on the computing device, for each consumer profile of the plurality of consumer profiles, a portion of the consumer data as anonymized consumer data and another portion of the consumer data as identifying consumer data; store the consumer data in the electronic memory accessible by the server computing system, wherein the consumer data is stored in association with the plurality of consumer profiles; validate accuracy of at least a portion of the consumer data with one or more data institutions, over an electronic communication network; detect a presence of a plurality of consumers; retrieve, by the server computing system from the electronic memory, anonymized consumer data for a consumer profile for each detected consumer of the plurality of consumers; and aggregate the anonymized consumer data for the plurality of consumers.

### Example 55

A system for obtaining consumer data, the system comprising: one or more processors; electronic memory accessible by the one or more processors; a network interface to enable communication over an electronic communication network with a system for facilitating anonymized and transparent exchange of information; a consumer detector to detect a consumer; and a vendor portal client to, by the one or more processors and the network interface, obtain anonymized consumer data for a detected consumer, wherein the vendor portal client obtains the anonymized consumer data from the system for facilitating anonymized and transparent exchange of information.

### Example 56

The system of Example 55, wherein the consumer detector comprises a radio frequency identification (RFID) reader at a location to detect a presence of an RFID tag of the consumer at the location.

### Example 57

The system of Example 55, wherein the consumer detector comprises a page view detector to detect the consumer viewing a webpage of the vendor.

### Example 58

The system of Example 55, further comprising a consumer data aggregator to, by the one or more processors, aggregate the anonymized consumer data for the consumer with anonymized consumer data for each of a plurality of detected consumers.

### Example 59

The system of Example 58, wherein the consumer data aggregator aggregates the anonymized consumer data according to criteria specifying consumer characteristics in the consumer anonymized data, wherein the criteria to be received from the vendor.

### Example 60

The system of Example 59, wherein the criteria are received from the vendor through the vendor portal client.

### Example 61

The system of Example 58, wherein the vendor portal client communicates detection of the consumer to the system for facilitating anonymized and transparent exchange of information for aggregation of the anonymized consumer data.

### Example 62

The system of Example 61, wherein the vendor portal client enables a vendor to specify criteria for data aggregation and communicates the criteria to the system for facilitating anonymized and transparent exchange of information for aggregation of the anonymized consumer data according to the criteria.

### Example 63

The system of Example 55, wherein the anonymized consumer data received comprises a portion of consumer data for the consumer that has been validated for accuracy by one or more data institutions.

### Example 64

The system of Example 55, wherein the vendor portal is further configured to enable the vendor to view the anonymized consumer data for the consumer.

### Example 65

The system of Example 55, wherein the vendor portal is further configured to present the anonymized consumer data to the consumer for viewing.

### Example 66

The system of Example 55, wherein the vendor portal is further configured to enable the vendor to present vendor offer data to the consumer, based on the anonymized consumer data.

### Example 67

The system of Example 55, wherein the vendor portal is further configured to enable the vendor, with authorization from the consumer, to request and view identifying consumer data for the consumer.

### Example 68

A computer-implemented method for obtaining information of consumers, the method comprising; detecting a consumer by utilizing a consumer detector; requesting consumer data for the consumer, wherein the requesting is over an electronic communications network to a system for facilitating anonymized and transparent exchange of information that stores a consumer profile for each of a plurality of consumers that includes consumer data and a consumer token, wherein a portion of the consumer data of the consumer profile is designated anonymized consumer data and another portion of the consumer data is designated identifying consumer data; and receiving anonymized consumer data from the system for facilitating anonymized and transparent exchange of information, over the electronic communications network.

### Example 69

The method of Example 68, wherein detecting the consumer comprises a radio frequency identification (RFID) reader detecting a presence of an RFID tag of the consumer at a location.

### Example 70

The method of Example 68, wherein detecting the consumer comprises a page view detector detecting the consumer viewing a webpage of the vendor.

### Example 71

The method of Example 68, further comprising aggregating the anonymized consumer data for the consumer with anonymized consumer data for each of a plurality of detected consumers.

### Example 72

The method of Example 68, wherein the anonymized consumer data received comprises a portion of consumer data that has been validated for accuracy by one or more data institutions.

### Example 73

The method of Example 68, further comprising presenting vendor offer data to the consumer, based on the anonymized consumer data.

### Example 74

The method of Example 68, further comprising: providing, over the communications network to the system for facilitating anonymized and transparent exchange of information, an indication of authorization from the consumer to access identifying consumer data for the consumer; receiving identifying consumer data from the system for facilitating anonymized and transparent exchange of information.

### Example 75

A computer-readable storage medium having stored thereon instructions that, when executed by one or more processors, cause a computing device to perform operations to: detect a consumer by using a consumer detector; request consumer data for the consumer from a system for facilitating anonymized and transparent exchange of information that stores a consumer profile for each of a plurality of consumers that includes consumer data and a consumer token, wherein a portion of the consumer data of the consumer profile is designated anonymized consumer data and another portion of the consumer data is designated identifying consumer data; and receive anonymized consumer data from the system for facilitating anonymized and transparent exchange of information, over the electronic communications network.

### Example 76

The computer-readable storage medium of Example 75, where in the instructions are further to cause operations to: provide, over the communications network to the system for facilitating anonymized and transparent exchange of information, an indication of authorization from the consumer to access identifying consumer data for the consumer; receive identifying consumer data from the system for facilitating anonymized and transparent exchange of information.

### Example 77

A system for presenting vendor data to consumers, the system comprising: one or more processors; electronic memory accessible by the one or more processors, the electronic memory to store consumer profiles that include consumer data and a consumer token, wherein a portion of the consumer data is designated anonymized consumer data and another portion of the consumer data is designated identifying consumer data; a network interface to enable communication over an electronic communication network with a vendor computing device and a consumer computing device; and a vendor portal to: receive from the vendor computing device vendor offer data providing vendor offer terms for a vendor offer targeted to one or more consumers, wherein the vendor offer terms are based on the anonymized consumer data for the one or more consumers, and transmit the vendor offer via a consumer portal for presentation to the one or more consumers.

### Example 78

The system of Example 77, wherein the vendor portal is further to, by the one or more processors and the network interface, transmit anonymized consumer data of consumers to a vendor computing device over the network, such that a vendor portal client on the vendor computing device can present the anonymized consumer data to the vendor.

### Example 79

The system of Example 77, wherein the vendor offer data comprises one or more rules that indicate one or more criteria specifying one or more consumer characteristics found in the anonymized consumer data, wherein the one or more rules are defined by the vendor.

### Example 80

The system of claim 3, wherein the vendor portal comprises a vendor offer engine to automatically generate the vendor offer based on the anonymized consumer data and the one or more rules.

### Example 81

The system of Example 77, wherein the vendor portal generates a plurality of vendor offers for a plurality of vendors.

### Example 82

The system of Example 77, further comprising a consumer portal to, by the one or more processors, enable a consumer to: upload to the system, for storage in the electronic memory, consumer data pertaining to a consumer profile for the consumer; authorize release of identifying consumer data of the consumer profile to a selected vendor, wherein authorization involves the consumer token of the consumer profile; and review vendor offer data from one or more vendors, including the selected vendor;

### Example 83

The system of Example 77, the consumer portal to, by the one or more processors, designate a portion of consumer data for the consumer profile as identifying consumer data and another portion of the consumer data for the consumer profile as anonymized consumer data.

### Example 84

The system of Example 77, further comprising a data validation engine to one or more of download consumer data for the consumer profile from one or more data institutions and validate accuracy of consumer data for the consumer profile with one or more data institutions by communication via the network interface over the network with a computing system of each of the one or more data institutions

### Example 85

The system of Example 77, the vendor portal further to enable a vendor to provide the consumer token to demonstrate consumer authorization to access identifying consumer data of the consumer profile.

### Example 86

A system for providing information to consumers, the system comprising: one or more processors; electronic memory accessible by the one or more processors; a network interface to enable communication over an electronic communication network with a system for facilitating anonymized and transparent exchange of information; and a vendor portal client to, by the one or more processors and the network interface, obtain anonymized consumer data of consumers, wherein the vendor portal client obtains the anonymized consumer data from the system for facilitating anonymized and transparent exchange of information, wherein the vendor portal client automatically generates a vendor offer of a vendor and targeted to one or more consumers, based on: the anonymized consumer data obtained for the one or more consumers, and one or more criteria specifying one or more consumer characteristics found in the anonymized consumer data, wherein the one or more criteria are defined by the vendor.

### Example 87

The system of Example 86, wherein the vendor portal client comprises a vendor offer engine to automatically generate the vendor offer based on the anonymized consumer data and the one or more criteria.

### Example 88

The system of Example 86, wherein the vendor portal client generates a plurality of vendor offers for a plurality of vendors.

### Example 89

The system of Example 86, the vendor portal further to enable a vendor to provide a consumer token to demonstrate consumer authorization to access identifying consumer data from the system for facilitating anonymized and transparent exchange of information.

### Example 90

A computer-implemented method for presenting vendor data to consumers, comprising: receiving, at a computing system, consumer data for a consumer profile stored in an electronic memory, a portion of the consumer data designated as anonymized consumer data associated with consumer profile; receiving, via a vendor computing device, vendor offer data providing vendor offer terms for a vendor offer targeted to one or more consumers, wherein the vendor offer terms are based on the anonymized consumer data for the one or more consumers; and communicating the vendor offer to a consumer computing device of each of the one or more consumers for presentation to the one or more consumers.

### Example 91

The method of Example 90, wherein the consumer data is received at a vendor portal client of a vendor computing device, over a network, from a system for facilitating anonymized and transparent exchange of information.

### Example 92

The method of Example 90, wherein the consumer data is received at a system for facilitating anonymized and transparent exchange of information, over a network, from a consumer computing device.

### Example 93

The method of Example 92, wherein the vendor offer data comprises one or more rules that indicate one or more criteria specifying one or more consumer characteristics found in the anonymized consumer data, wherein the one or more rules are defined by the vendor, the method further comprising: automatically generating, by one or more processors, the vendor offer based on the anonymized consumer data and the one or more rules.

### Example 94

The method of Example 92, further comprising: designating another portion of the consumer data as identifying consumer data, wherein the profile includes a consumer token that provides authorization to access the identifying consumer data; transmitting the identifying consumer data to a vendor, if the consumer token is presented to demonstrate authorization to access.

### Example 95

The method of Example 92, further comprising validating accuracy of the consumer data for the consumer profile with one or more data institutions by communication over the network with a computing system of each of the one or more data institutions.

### Example 96

A system for anonymously requesting organization data from an organization, comprising: one or more processors; electronic memory accessible by the one or more processors, the electronic memory to store user profiles that include user data, wherein a portion of the user data is designated anonymized user data and another portion of the user data is designated identifying user data; a network interface to enable communication over an electronic communication network with an organization computing device and a user computing device; and a user portal to, by the one or more processors: receive user data via the network interface from a user computing device for storage in the electronic memory, the user data pertaining to a user profile for the user; designate a portion of the user data for the for the profile as identifying user data and another portion of the user data for the user profile as anonymized user data; and request organization data from an organization, based on the anonymized user data; a data validation engine to one or more of: (i) download, via the network interface over the network, validated user data for the user profile from a computing system of one or more data institutions and (ii) validate accuracy of user data with one or more data institutions to produce validated user data for the user profile by communication via the network interface over the network with a computing system of each of the one or more data institutions; and an organization portal to, by the one or more processors: receive organization data from the organization computing device via the network interface, the organization data including rules for determining terms of organization response data according to criteria specifying user characteristics found in the anonymized user data; generate organization response data, based on validated anonymized user data for the user profile and the rules; and transmit the organization response data to the user computing device for presentation to the user.

### Example 97

The system of Example 96, wherein the user portal further enables a user to consent to release of anonymized user data of the user profile to a selected vendor.

### Example 98

The system of Example 96, wherein the user is a consumer and the organization is a vendor and the organization response data is vendor offer data.

### Example 99

The system of Example 98 wherein the vendor offer data provides an offer for financial services.

### Example 100

The system of Example 96, wherein the organization portal further enables an organization to provide the token to demonstrate authorization to access the identifying user data of the corresponding user profile.

### Example 101

The system of Example 96, wherein each user profile includes a token that provides authorization to access the identifying user data of the user profile, and wherein the organization portal can access identifying user data for a given consumer profile, if the organization presents the token of the given user profile.

### Example 102

A system for anonymously requesting data, the system comprising: one or more processors; electronic memory accessible by the one or more processors; a network interface to enable communication over an electronic communication network with a system for facilitating anonymized and transparent exchange of information; and a consumer portal client to, by the one or more processors and the network interface, enable a consumer to: provide consumer data to the system for facilitating anonymized and transparent exchange of information, the consumer data to be processed to designate a portion of the consumer data as anonymized consumer data and another portion of the consumer data as identifying consumer data, wherein the system for facilitating anonymized and transparent exchange of information can provide the anonymized consumer data for access to one or more vendors; and receive vendor information from the system for facilitating anonymized and transparent exchange of information, the vendor information received based on the anonymized consumer data.

### Example 103

The system of Example 102, wherein the consumer portal client enables the consumer to define preferences for vendor characteristics of vendors from which vendor information is requested and received, wherein the preferences are stored in the electronic memory.

### Example 104

The system of Example 102, wherein the consumer portal client is further to enable the consumer to authorize release identifying consumer data to a specific vendor.

### Example 105

The system of claim 8, wherein the authorization comprises a token delivered to the vendor.

### Example 106

The system of Example 102, wherein the consumer portal client is further to enable the consumer to authorize release identifying consumer data to a specific vendor, in response to vendor information received from the system for facilitating anonymized and transparent exchange of information.

### Example 107

A consumer system for providing information to vendors, the system comprising: one or more processors; electronic memory accessible by the one or more processors; a network interface to enable communication over an electronic communication network with a system for facilitating anonymized and transparent exchange of information; and a consumer portal client to, by the one or more processors and the network interface, enable a consumer to: provide consumer data to the system for facilitating anonymized and transparent exchange of information, the consumer data to be processed to designate a portion of the consumer data as anonymized consumer data and another portion of the consumer data as identifying consumer data, wherein the system for facilitating anonymized and transparent exchange of information provides the anonymized consumer data for access to one or more vendors; and receive vendor data from the system for facilitating anonymized and transparent exchange of information, the vendor information received based on the anonymized consumer data; and an authorization token to be communicated to the system for facilitating anonymized and transparent exchange of information in order to authorize release of consumer identifying information from the system for facilitating anonymized and transparent exchange of information to the vendor.

### Example 108

A computer-implemented method for anonymously requesting organization data from an organization, comprising receiving user data via a network interface from a user computing device, the user data pertaining to a user profile for the user, the user profile stored in an electronic memory; designating a portion of the user data for the for the profile as identifying user data and another portion of the user data for the user profile as anonymized user data; validating at least a portion of the user data with one or more data institutions over an electronic network to produce validated consumer data; receiving organization data over a network from an organization computing device, the organization data including rules for determining terms of organization response data according to criteria specifying user characteristics found in the anonymized user data; generating organization response data, based on validated anonymized user data for the user profile and the rules; and transmitting the organization response data to the user computing device for presentation to the user.

### Example 109

The method of Example 108, further comprising requesting organization data from the organization, based on the anonymized user data.

### Example 110

The method of Example 108, further comprising communicating the validated anonymized user data to a vendor computing device for presentation to the vendor.

### Example 111

The method of Example 108, wherein each user profile includes a token that provides authorization to access the identifying user data of the user profile, and wherein the methods further comprises: receiving a token for a given user profile from a vendor computing device to demonstrate authorization of the vendor to access the identifying user data for the given consumer profile; communicating the identifying user data to the vendor computing device for presentation to the vendor.

The foregoing specification has been described with reference to various embodiments. However, those skilled in the art appreciate that various modifications and changes can be made without departing from the scope of the present disclosure and the underlying principles of the invention. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

While the principles of this disclosure have been shown in various embodiments, many modifications of structure, arrangements, proportions, the elements, materials and components, used in practice, which are particularly adapted for a specific environment and operating requirements, may be used without departing from the principles and scope of this disclosure. These and other changes or modifications are intended to be included within the scope of the present disclosure.

We claim:

1. A system for aggregating data of a plurality of consumers, the system comprising:
one or more processors;
electronic memory accessible by the one or more processors, the electronic memory to store a plurality of consumer profiles that each include consumer data and a consumer token, wherein for each of the plurality of consumer profiles a portion of the consumer data is designated anonymized consumer data and another portion of the consumer data is designated identifying consumer data;
a network interface to enable communication with one or more computing devices over an electronic communication network;
a data validation engine to, by the one or more processors, validate accuracy of consumer data for the consumer profile with one or more data institutions by communication over the network with a computing system of each of the one or more data institutions via the network interface; and
a consumer detector to detect consumers and, in response to detection of a consumer and by the one or more processors, to retrieve from the electronic memory the anonymized consumer data for a consumer profile for each detected consumer; and
a consumer data aggregator to, by the one or more processors, aggregate the retrieved anonymized consumer data for the consumer profile for the detected consumer with anonymized consumer data of other detected consumers.

2. The system of claim 1, further comprising a consumer portal to, by the one or more processors:
enable a consumer to upload to the system, for storage in the electronic memory, consumer data pertaining to a consumer profile for the consumer; and
designate a portion of consumer data for the consumer profile as identifying consumer data and another portion of the consumer data for the consumer profile as anonymized consumer data.

3. The system of claim 1, further comprising:
a vendor portal to, by the one or more processors:
enable a vendor to one or more of:
view aggregated anonymized consumer data; and
based on the aggregated anonymized consumer data, present vendor offer data to a consumer computing device over the network.

4. The system of claim 1, wherein the consumer detector detects consumers at a vendor location.

5. The system of claim 4, wherein the vendor location is a physical location.

6. The system of a claim 5, wherein the consumer detector comprises radio frequency identification (RFID) technology to detect RFID tags associated with consumers at the physical location.

7. The system of claim 4, wherein the vendor location is a virtual location.

8. The system of claim 1, wherein the consumer detector detects consumers at a target location.

9. The system of claim 1, wherein the consumer data aggregator aggregates the anonymized consumer data according to criteria specifying consumer characteristics in the consumer anonymized data, wherein the criteria to be received from the vendor.

10. The system of claim 1, wherein the consumer token comprises a tangible object that includes one or more of a pin number, a password, and a reference number.

11. A computer-implemented method for aggregating consumer data, the method comprising:
receiving, at a server computing system, consumer data pertaining to a plurality of consumer profiles stored in an electronic memory accessible by the server computing system, each consumer profile of the plurality of consumer profiles including a consumer token that is unique;
designating on the server computing system, for each consumer profile of the plurality of consumer profiles, a portion of the consumer data as anonymized consumer data and another portion of the consumer data as identifying consumer data;
storing the consumer data in the electronic memory accessible by the server computing system, wherein the consumer data is stored in association with the plurality of consumer profiles;
receiving, at the server computing system over an electronic communication network, from one or more data institutions, a notice of validation of accuracy of at least a portion of the consumer data;
detecting a presence of a plurality of consumers;
in response to detection of each detected consumer of the plurality of consumers, retrieving, by the server computing system from the electronic memory, anonymized consumer data for a consumer profile for the detected consumer of the plurality of consumers; and
aggregating the retrieved anonymized consumer data with retrieved anonymized consumer data of other detected consumers of the plurality of consumers.

12. The method of claim 11, further comprising:
providing one or more vendors with access, over the electronic communication network, to aggregated anonymized consumer data for the plurality of consumers.

13. The method of claim 12, further comprising:
enabling one or more vendors to present, over the electronic communication network, vendor offer data based on the aggregated anonymized consumer data for the plurality of consumers.

14. The method of claim 11, further comprising:
transmitting, over the electronic communication network, aggregated anonymized consumer data for a plurality of consumers to a vendor computing device of a vendor.

15. The method of claim 11, wherein detecting the plurality of consumers comprises detecting a consumer at a vendor location.

16. The method of claim 15, wherein the vendor location is a physical location.

17. The method of claim 11, wherein detecting the plurality of consumers comprises utilizing radio frequency identification (RFID) technology to detect RFID tags associated with consumers at the physical location.

18. The method of claim 15, wherein the vendor location is a virtual location.

19. The method of claim 18, wherein the virtual location is a website.

20. The method of claim 11, further comprising:
requesting the one or more data institutions validate the accuracy of at least a portion of the consumer data.

21. A computer readable storage medium having stored thereon instructions that, when executed by one or more processors, cause a computing device to perform operations to:
receive, at the computing device, consumer data pertaining to a plurality of consumer profiles stored in an electronic memory accessible by the computing device, each consumer profile of the plurality of consumer profiles including a consumer token that is unique;
designate on the computing device, for each consumer profile of the plurality of consumer profiles, a portion of the consumer data as anonymized consumer data and another portion of the consumer data as identifying consumer data;
store the consumer data in the electronic memory accessible by the server computing system, wherein the consumer data is stored in association with the plurality of consumer profiles;
validate accuracy of at least a portion of the consumer data with one or more data institutions, over an electronic communication network;
detect a presence of a plurality of consumers;
retrieve, by the server computing system from the electronic memory and in response to detection of a consumer, anonymized consumer data for a consumer profile for each detected consumer of the plurality of consumers; and
aggregate the anonymized consumer data for the plurality of consumers.

22. The system of claim 1, wherein the consumer data aggregator, by the one or more processors, is further to process aggregated anonymized consumer data to identify at least one common characteristic of a set of detected consumers.

23. The system of claim 1, wherein the consumer data aggregator, by the one or more processors, is further to provide a specific slice of aggregated anonymized consumer data to a vendor portal, according to one or more criteria designated by the vendor via the vendor portal.

24. The system of claim 1, wherein the consumer data aggregator, by the one or more processors, is further to bundle aggregated anonymized consumer data according to one or more consumer tracking metrics.
